(19) United States
(12) Patent Application Publication
(10) Pub. No.: US 2026/0267074 A1
(43) Pub. Date: Sep. 10, 2026

(54) OPTICAL CONNECTOR AND RECEPTACLE FOR CO-PACKAGED OPTICS

(71) Applicant: CORNING RESEARCH & DEVELOPMENT CORPORATION, CORNING, NY (US)

(72) Inventors: Micah Colen Isenhour, Lexington, NC (US); Andreas Matiss, Berlin (DE); Eric Stephan ten Have, Berlin (DE)

(21) Appl. No.: 19/665,447

(22) Filed: May 1, 2026

Related U.S. Application Data
(63) Continuation of application No. PCT/US2024/053774, filed on Oct. 31, 2024.
(60) Provisional application No. 63/547,024, filed on Nov. 2, 2023.

(51) Int. Cl. G02B 6/30; G02B 6/26; G02B 6/32; G02B 6/36; G02B 6/38; G02B 6/42

(52) U.S. Cl. CPC G02B 6/30; G02B 6/262; G02B 6/32; G02B 6/3636; G02B 6/3882; G02B 6/4206; G02B 6/4231; G02B 6/4236

(57) ABSTRACT

An assembly for expanded beam coupling a fiber array unit (FAU) to a photonic integrated circuit (PIC) is provided. The assembly comprises the photonic integrated circuit (PIC), a PIC micro lens array attached to the photonic integrated circuit, and the FAU. The FAU comprises one or more grooves, with each of the groove(s) being configured to receive a fiber therein. The assembly also includes an FAU micro lens array attached to the FAU, and the FAU micro lens array is offset from the PIC micro lens array by a first distance. The assembly also includes at least one alignment feature configured to control an angular alignment of the PIC micro lens array relative to the FAU micro lens array.

### RELATED APPLICATIONS

This application is a continuation of International Patent Application Serial No. PCT/US2024/053774 filed on Oct. 31, 2024, which claims the benefit of priority of U.S. Provisional Application Ser. No. 63/547,024 filed on Nov. 2, 2023. The content of each aforementioned application is relied upon and incorporated herein by reference in its entirety.

### FIELD

Embodiments relate generally to assemblies with a connector that is configured to couple to waveguides in a silicon photonic assembly using an expanded beam approach, and methods for making the same.

### BACKGROUND

In silicon photonics, silicon is used as an optical medium, with the wavelength falling primarily in a near infrared (NIR) wavelength band around wavelengths of 1.31 micrometers and 1.55 micrometers. These wavelengths are often used in telecommunications. The method of injecting or extracting light into and out of the silicon photonic assemblies presents problems with silicon photonics that have not yet been solved. In telecommunications, light is usually transported in fibers, and these fibers must be effectively coupled to the silicon photonic integrated circuit (PIC).

The difference in mode field diameters presents one difficulty in coupling light to silicon PICs. Single mode fibers have a mode field diameter of about 10 micrometers, while modes in silicon waveguides may have a size of less than one micron because of the large refractive index of silicon (about 3.5). This difference often leads to high coupling losses where fibers are coupled directly to the silicon photonic waveguides. To reduce these coupling losses, mode converters are required to scale the modes of the silicon photonic to the size of the fiber modes.

Improvements in the foregoing are desired.

### BRIEF SUMMARY

There are three different approaches for coupling light into silicon photonic waveguides. A first approach for coupling light into silicon photonic waveguides is through evanescent coupling. For evanescent coupling, a waveguide in the silicon is brought into close proximity with a glass waveguide so that light is able to couple evanescently from the silicon to the glass and vice versa. With the evanescent coupling, the mode field conversion may be built into the geometry of the glass waveguides, and fibers may then directly be coupled to the glass waveguides.

A second approach for coupling light into silicon photonic waveguides is through grating coupling. With this grating coupling approach, PICs use grating couplers as an interface, and the light path is approximately perpendicular to the surface of a silicon photonic assembly. Grating couplers may be located anywhere on the surface of the silicon photonic assembly. While grating couplers can be designed such that they easily couple to single mode fibers, they have a limited bandwidth so that they cannot support many different wavelengths (e.g., for wavelength-division multiplexing (WDM) applications). Also, where grating coupling is used, fibers are oriented so that they extend perpendicularly relative to the surface of the silicon photonic assembly, and this fiber orientation poses limits on the geometry and arrangements in which these silicon photonic assemblies may be used.

A third approach for coupling light into silicon photonic waveguides is through edge coupling. With this edge coupling approach, waveguides of the silicon photonic assembly are interfaced with and end at the edge of a silicon photonic assembly. Edge coupling approaches often require separate mode field converters to couple to fibers. These may be realized in the silicon and/or may be realized as an additional interposer chip, where the conversion is realized through changing the waveguide size along the length. These may also be realized through imaging optics.

There are also different techniques for edge coupling. In a first technique, fibers are directly attached to the silicon photonic assembly. With this direct attachment approach the fibers are attached directly to waveguides in the silicon photonic assembly, and this may be accomplished using adhesive for physical attachment and refractive index matching. Alignment structures such as fiber array units and other mechanical features such as grooves may assist in facilitating direct attachment of fibers. With the direct attachment approach, fibers are often permanently attached, preventing connectors from being re-matable to other silicon photonic assemblies. In a second technique for edge coupling, relay optics are used to couple fibers to a silicon photonic assembly. With relay optics, a single lensing element is attached either to the fibers in a fiber array unit (FAU) or to the silicon photonic assembly, and the lensing element images waveguides onto the fibers and vice versa.

Embodiments herein relate generally to assemblies including a connector that is configured to couple to waveguides in a silicon photonic assembly using an expanded beam approach and methods for making the same. Assemblies may include multiple connectors and multiple silicon photonic assemblies in some embodiments. With an expanded beam approach, an optical connection may contain two lensing elements in the form of micro lens array. One lensing element may be attached to the fibers and the other lensing element may be attached the silicon photonic assembly. However, in some embodiments, expanded beam solutions may be deployed with other edge coupled assemblies, and parameters of optical connections may be adjusted to accomplish this. A mode converter may be built into the silicon photonic assembly.

Connectors and receptacles may assist in providing fiber connectivity to a silicon photonic assembly. Furthermore, connectors may be provided that are easily re-matable to photonic integrated circuits in silicon photonic assemblies, enabling connectors to be mated and removed to allow the connectors to be reused multiple times with different silicon photonic assemblies. These connectors may assist in providing optical connectivity to co-packaged silicon photonics assemblies. Connectors may include a reflow-capable receptacle for attachment to the silicon photonic assembly, with the reflow-capable receptables being able to withstand high temperatures of a solder reflow cycle without significant deterioration of the optical signal level. The receptacle, the connector, and the components within the connector may enable a high-precision alignment.

Example connector assemblies described herein help facilitate connections to photonic integrated circuits (PICs) in silicon photonic assemblies. Connector assemblies may be used in co-packaged optics, and connector assemblies may use silicon photonics in some embodiments. By using silicon photonics, existing semiconductor fabrication methods and infrastructure may be used. Additionally, by using silicon photonics, electronics and photonics may be integrated into a single silicon photonic assembly as photonic integrated circuits (PIC) or at least into components that work closely together.

In an example embodiment, an assembly for expanded beam coupling a fiber array unit (FAU) to a photonic integrated circuit (PIC) is provided. The assembly comprises the PIC, a PIC micro lens array attached to the PIC, and the FAU. The FAU comprises one or more grooves, with each of the groove(s) being configured to receive a fiber therein. The assembly also comprises an FAU micro lens array attached to the FAU, with the FAU micro lens array being offset from the PIC micro lens array by a first distance. The assembly also includes at least one alignment feature configured to control an angular alignment of the PIC micro lens array relative to the FAU micro lens array.

In some embodiments, the assembly may be configured so that an optical beam emitted between the PIC micro lens array and the FAU micro lens array has a diameter at the PIC micro lens array that is approximately the same as a diameter at the FAU micro lens array. Furthermore, in some embodiments, the assembly may also comprise a pin, and the pin may be configured to align the FAU relative to the PIC. In some embodiments, the FAU may define a FAU pin groove that is configured to receive a first portion of the pin therein. Additionally, in some embodiments, the alignment feature(s) may include a receptacle defining a receptacle pin groove configured to receive a second portion of the pin therein. Also, in some embodiments, receipt of the pin within the pin groove may align the FAU relative to the receptacle. In some embodiments, the PIC micro lens array and the FAU micro lens array may be positioned proximate to the receptacle. In some embodiments, the assembly may also comprise a plate comprising a first surface and a second surface opposite the first surface, and the assembly may also comprise a housing configured to maintain positioning of the FAU relative to the receptacle. The housing may comprise a plurality of retention walls including a first retention wall and a second retention wall offset from the first retention wall by an offset distance, and retention walls may define an interior volume within the housing. The alignment feature(s) may include the housing, and the housing may be configured to receive at least a portion of the plate, the receptacle, and the FAU in the interior volume of the housing. The first surface of the plate may be positioned in contact with the first retention wall of the housing, and the receptacle may be positioned in contact with the second surface of the plate. The second retention wall may be positioned in contact with the FAU to maintain a position of the FAU relative to the plate and the receptacle. Additionally, in some embodiments, the plurality of retention walls may include a third retention wall, the first retention wall and the third retention wall may extend in different planes, and the first retention wall and the third retention wall may each contact at least one of the plate, the receptacle, or the FAU to assist in controlling alignment.

In some embodiments, the PIC micro lens array may be directly attached to the FAU. Additionally, in some embodiments, the FAU micro lens array may be directly attached to the FAU. Furthermore, in some embodiments, each of the plurality of grooves may be V-grooves. In some embodiments, the assembly may also include a second housing, a third housing, a second fiber array unit, and a third fiber array unit, the second housing may be configured to maintain positioning of the second fiber array unit, the third housing may be configured to maintain positioning of the third fiber array unit, and the second housing may be offset along a first direction relative to the first housing and the third housing.

In another example embodiment, a connector for connection to a photonic integrated circuit (PIC) by expanded beam coupling is provided. The connector comprises a fiber array unit (FAU). The FAU comprises one or more grooves, with each of the groove(s) being configured to receive a fiber therein. The connector also comprises an FAU micro lens array attached to the FAU, at least one alignment feature configured to control an angular alignment of the FAU micro lens array relative to a PIC micro lens array. The FAU micro lens array is configured to be offset from the PIC micro lens array of the PIC by a first distance, and the alignment feature(s) are configured to assist in controlling an angular alignment of the FAU micro lens array relative to the PIC micro lens array.

In some embodiments, the connector may comprise a plate comprising a first surface and a second surface opposite the first surface. The connector may also comprise a housing configured to maintain positioning of the FAU relative to the receptacle. The housing may comprise a plurality of retention walls including a first retention wall and a second retention wall offset from the first retention wall by an offset distance, and the plurality of retention walls may define an interior volume within the housing. The alignment feature(s) may include the housing, and the housing may be configured to receive at least a portion of the plate, the receptacle, and the fiber array unit in the interior volume of the housing. The first surface of the plate may be positioned in contact with the first retention wall of the housing, the receptacle may be positioned in contact with the second surface of the plate, and the second retention wall may be positioned in contact with the FAU to maintain a position of the FAU relative to the plate and the receptacle. Furthermore, in some embodiments, the plurality of retention walls may include a third retention wall, the third retention wall may extend in a different plane relative to the first retention wall, and the first retention wall and the third retention wall may each contact at least one of the plate, the receptacle, or the FAU to assist in controlling alignment. Additionally, in some embodiments, the connector may be configured so that an optical beam emitted between the PIC micro lens array and the FAU micro lens array has a diameter at the PIC micro lens array that is approximately the same as a diameter at the FAU micro lens array.

In another example embodiment, a method for manufacturing an expanded beam coupling assembly is provided. The method comprises providing fiber array unit (FAU) comprising one or more grooves and positioning a plurality of fibers within the FAU such that each fiber is positioned at least partially within a respective groove of the plurality of grooves. The method also includes positioning the FAU relative to a receptacle, positioning a FAU micro lens array on the receptacle relative to the FAU, positioning a photonic integrated circuit (PIC) micro lens array on the receptacle so that the PIC micro lens array is offset from the FAU micro lens array by a first distance, positioning a PIC relative to the receptacle so that the PIC is positioned proximate to the PIC micro lens array, and positioning at least one alignment feature to control an angular alignment of the FAU micro lens array relative to the PIC micro lens array. In some embodiments, the positioning of the FAU micro lens array on the receptacle relative to the FAU may be accomplished by attaching the FAU micro lens array to the fiber array unit. Furthermore, in some embodiments, the FAU micro lens array may be positioned so that an optical beam emitted between the PIC micro lens array and the FAU micro lens array has a diameter at the PIC micro lens array that is approximately the same as a diameter at the FAU micro lens array.

In some embodiments, the FAU may comprise a FAU pin groove and the receptacle may comprise a receptacle pin groove, and positioning the FAU relative to the receptacle may be accomplished by positioning a pin so that the pin extends partially within the FAU pin groove and partially within the receptacle pin groove. In some embodiments, the PIC may be positioned proximate to the PIC micro lens array by directly attaching the photonic integrated circuit to the PIC micro lens array. In some embodiments, the PIC may be positioned proximate to the PIC micro lens array by attaching the receptacle to one or more intermediate components and by attaching the one or more intermediate components to the PIC.

In some embodiments, the alignment feature(s) include a housing and a receptacle. The housing may be configured to maintain positioning of the FAU relative to the receptacle. The housing may comprise a plurality of retention walls including a first retention wall and a second retention wall offset from the first retention wall by an offset distance, the plurality of retention walls may define an interior volume within the housing, and the receptacle may define a receptacle pin groove configured to receive a portion of a pin therein. The method may also comprise providing a plate comprising a first surface and a second surface opposite the first surface, receiving at least a portion of the plate, the receptacle, and the FAU in the interior volume of the housing, positioning the plate relative to the housing so that the first surface of the plate is in contact with the first retention wall of the housing, positioning the receptacle so that the receptacle is in contact with the second surface of the plate, and positioning the second retention wall in contact with the fiber array unit to maintain a position of the FAU relative to the plate and the receptacle.

In another example embodiment, an expanded beam coupling assembly is provided that is made by a particular process. This process includes providing a fiber array unit (FAU) comprising a plurality of grooves and positioning a plurality of fibers within the FAU, with each fiber being positioned at least partially within a respective groove of the plurality of grooves. This process also includes positioning the FAU relative to a receptacle, positioning a FAU micro lens array on the receptacle relative to the FAU, positioning a photonic integrated circuit (PIC) micro lens array on the receptacle so that the PIC micro lens array is offset from the FAU micro lens array by a first distance, and positioning a PIC relative to the receptacle so that the PIC is positioned proximate to the PIC micro lens array.

### BRIEF DESCRIPTION OF THE DRAWINGS

Reference will now be made to the accompanying drawings, which are not necessarily drawn to scale, and wherein:

FIG. 1 is a schematic view illustrating an example assembly with an expanded beam connection between a silicon photonic assembly and a connector, in accordance with some embodiments discussed herein;

FIG. 2 is a schematic view illustrating an example assembly using alignment techniques for controlling the alignment of an assembly using an expanded beam connection approach, in accordance with some embodiments discussed herein;

FIG. 3A illustrates a graph showing coupling loss for an arrangement of single mode waveguide assemblies having a gap and a lateral offset between single mode waveguide assemblies, in accordance with some embodiments discussed herein;

FIG. 3B illustrates a graph showing coupling loss for an arrangement of single mode waveguide assemblies having a gap and an angular offset between single mode waveguide assemblies, in accordance with some embodiments discussed herein;

FIG. 3C illustrates a graph showing coupling loss for an arrangement of single mode waveguide assemblies having a gap, an angular offset, and a lateral offset between single mode waveguide assemblies, in accordance with some embodiments discussed herein;

FIG. 4A illustrates a graph showing coupling loss for an arrangement of micro lens arrays having a gap and a lateral offset between micro lens arrays, in accordance with some embodiments discussed herein;

FIG. 4B illustrates a graph showing coupling loss for an arrangement of micro lens arrays having a gap and an angular offset between micro lens arrays, in accordance with some embodiments discussed herein;

FIG. 4C illustrates a graph showing coupling loss for an arrangement of micro lens arrays having a gap, an angular offset, and a lateral offset between micro lens arrays, in accordance with some embodiments discussed herein;

FIG. 5A is a schematic view illustrating an example of arrangement of micro lens arrays where a symmetrical beam is formed between the micro lens arrays, in accordance with some embodiments discussed herein;

FIG. 5B is a schematic view illustrating an example of arrangement of micro lens arrays where an asymmetrical beam is formed between the micro lens arrays, in accordance with some embodiments discussed herein;

FIG. 6 illustrates a graph showing the received beam diameter that is provided when different emitting beam diameters and different gap sizes are used, in accordance with some embodiments discussed herein;

FIG. 7 illustrates a graph showing the received beam diameter that is provided when different emitting beam diameters and different gap sizes are used, with the graph including a plotline showing the recommended minimum beam diameter that is used to maintain a symmetrical beam, in accordance with some embodiments discussed herein;

FIG. 8A is a graph illustrating the ratio between angular and lateral offsets required to cause the same amount of coupling loss, in accordance with some embodiments discussed herein;

FIG. 8B is a graph illustrating coupling losses that occur when different emitting beam diameters and gap sizes are used, in accordance with some embodiments discussed herein;

FIG. 9A is a perspective view illustrating an example assembly where a housing is utilized to maintain alignment of fiber array units, micro lens arrays, receptacles, and a plate, in accordance with some embodiments discussed herein;

FIG. 9B is a front view illustrating the example assembly of FIG. 9A where fiber array units are hidden for the purposes of illustration, in accordance with some embodiments discussed herein;

FIG. 9C is a perspective view illustrating various components of the example assembly of FIG. 9A where the housing is hidden for the purposes of illustration, in accordance with some embodiments discussed herein;

FIG. 10 is a perspective view illustrating an example housing, in accordance with some embodiments discussed herein;

FIG. 11 is a front view illustrating various example fiber array units having grooves for fibers and for pins, in accordance with some embodiments discussed herein;

FIG. 12 is a cross-sectional view illustrating an example connector, in accordance with some embodiments discussed herein;

FIG. 13A is a flow chart illustrating an example method for assembling a connector and attaching the connector to a photonic integrated circuit of a silicon photonic assembly, in accordance with some embodiments discussed herein;

FIG. 13B is a flow chart illustrating an example method for assembling a fiber array unit, in accordance with some embodiments discussed herein;

FIG. 13C is a flow chart illustrating an example method for attaching an FAU micro lens array to a receptacle, in accordance with some embodiments discussed herein;

FIG. 13D is a flow chart illustrating an example method for positioning a photonic integrated circuit micro lens array relative to a receptacle, in accordance with some embodiments discussed herein;

FIG. 13E is a flow chart illustrating an example method for positioning a receptacle relative to a photonic integrated circuit of a silicon photonic assembly, in accordance with some embodiments discussed herein; and

FIG. 13F is a flow chart illustrating another example method for positioning a receptacle relative to a photonic integrated circuit of a silicon photonic assembly, in accordance with some embodiments discussed herein.

### DETAILED DESCRIPTION

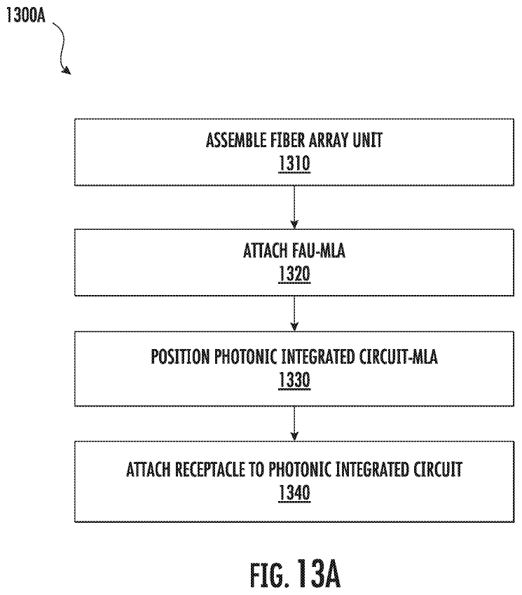

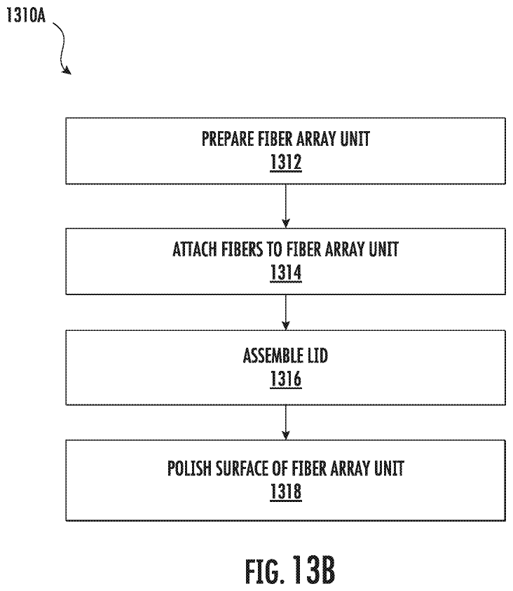

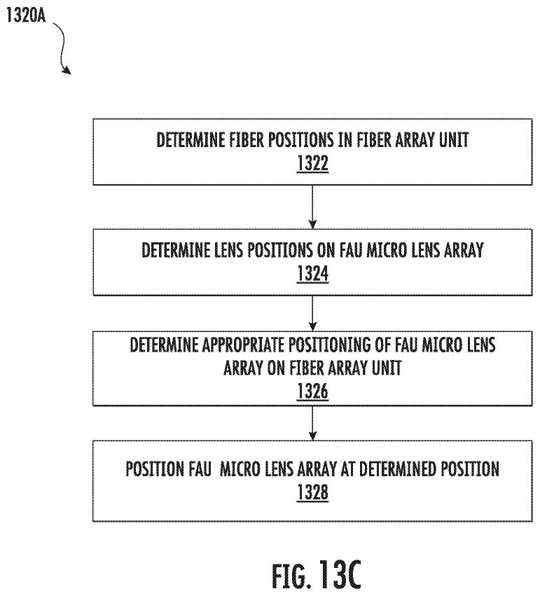

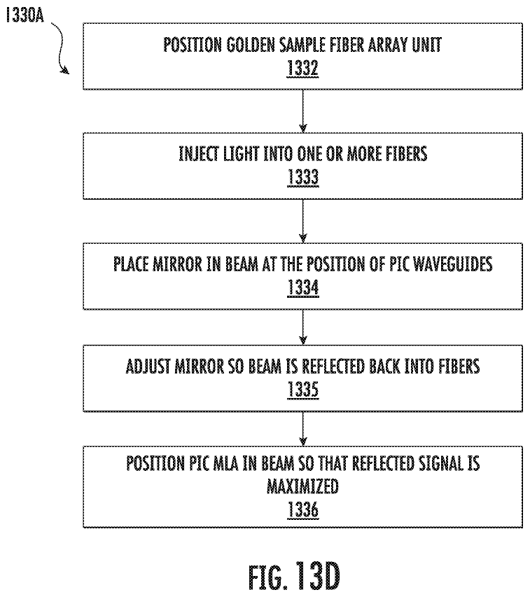

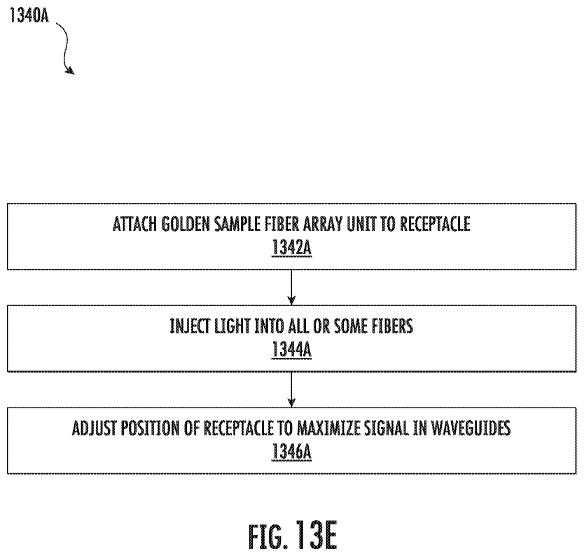

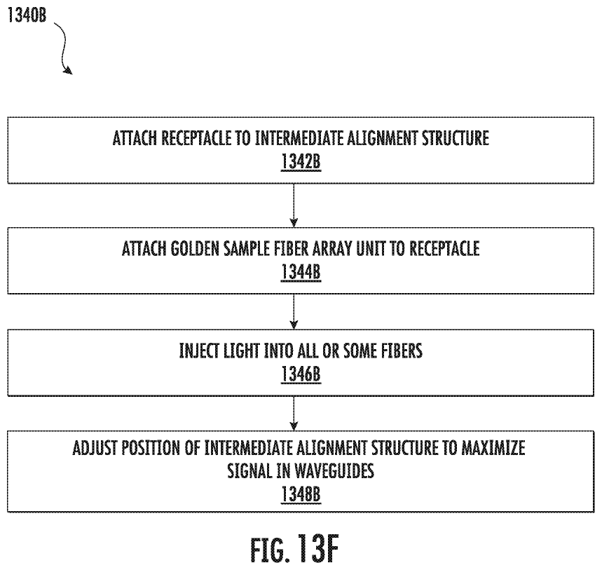

Example embodiments now will be described more fully hereinafter with reference to the accompanying drawings, in which some, but not all embodiments are shown. With the exception of FIGS. 13A-13F, like reference numerals generally refer to like elements. For example, reference numbers 946A, 946B, 946C, and 1046 are each used for a housing. Additionally, any connections or attachments may be direct or indirect connections or attachments unless specifically noted otherwise.

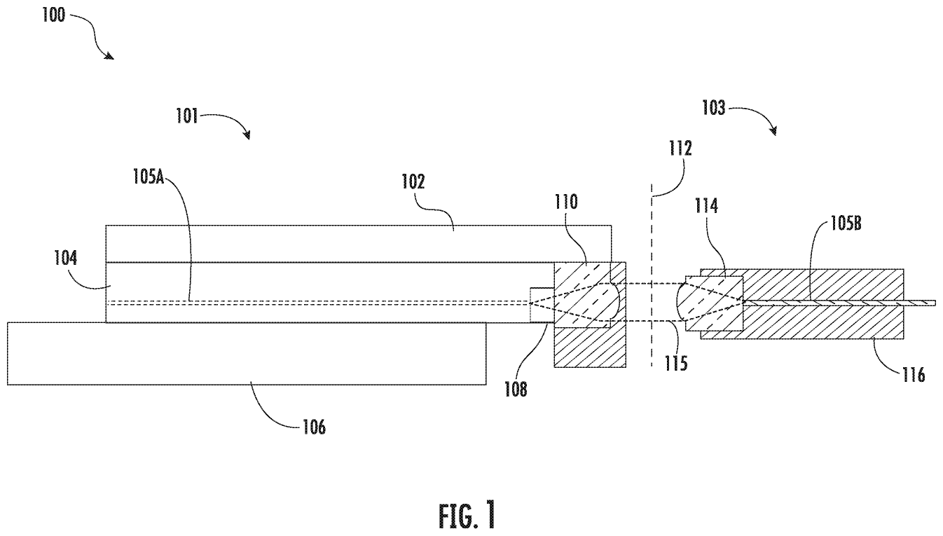

Some embodiments described herein relate to assemblies having an expanded beam connection between a silicon photonic assembly and a connector, and FIG. 1 illustrates one example assembly 100. The assembly 100 includes a silicon photonic assembly 101 and a connector 103. The expanded beam approach enables connectivity between the connector 103 and the silicon photonic assembly 101. The silicon photonic assembly 101 includes a plate 102, a photonic integrated circuit 104, a substrate 106, index matching gel 108, and a photonic integrated circuit (PIC) micro lens array 110. One or more waveguides 105A may be positioned within the photonic integrated circuit 104. Additionally, the connector 103 includes a fiber array unit (FAU) micro lens array 114 and a body 116. One or more fibers 105B may be positioned within the body 116 of the connector 103. An expanded beam portion 115 extends between the PIC micro lens array 110 and the FAU micro lens array 114, and a connection separation line 112 extends through this expanded beam portion 115.

In the silicon photonic assembly 101, the PIC micro lens array 110 may be attached directly to the photonic integrated circuit 104 in some embodiments. However, in other embodiments, the PIC micro lens array 110 may be attached indirectly to the photonic integrated circuit 104 such that the PIC micro lens array 110 is fixed relative to the photonic integrated circuit 104. For example, the PIC micro lens array 110 may be attached directly to the plate 102, and the plate 102 may be attached directly to the photonic integrated circuit 104. However, one or more intermediate structures may be used instead of the plate 102 in some embodiments.

In some embodiments, index matching gel 108 may be positioned between the substrate 106 and the PIC micro lens array 110 as illustrated in FIG. 1, and this index matching gel 108 may comprise adhesive material in some embodiments. However, in other embodiments, the PIC micro lens array 110 may be positioned adjacent to waveguides in the silicon photonic assembly 101 and no index matching gel 108 may be necessary. Furthermore, while a plate 102 is included in the assembly 100, other assemblies may be provided without any such plate. Anti-reflective coating may be used in assembly 100 to lower losses that may occur from differences in refractive indexes (e.g., between air and glass, between a photonic integrated circuit and glass, etc.), but anti-reflective coating may be omitted in other assemblies.

Photonic integrated circuits (PICs) may be provided in a variety of forms. Photonic integrated circuits may comprise waveguides therein, and between 5 and 30 waveguides may be provided in the photonic integrated circuits in some embodiments, with waveguides provided with a pitch of between about 75 micrometers and about 300 micrometers or between about 84 micrometers and about 250 micrometers. However, a different number of waveguides may be provided in other photonic integrated circuits. Some photonic integrated circuits may comprise grooves such as V-grooves, and these grooves may be positioned between waveguides and the PIC micro lens array 110. In some embodiments, a photonic integrated circuit may comprise a width of between about 2 millimeters and about 33 millimeters. In some embodiments, photonic integrated circuits may be provided without features to facilitate passive alignment. In some embodiments, multiple photonic integrated circuits may be attached to another substrate to form a silicon photonic assembly, with these photonic integrated circuits spaced apart from each other. Photonic integrated circuits may be provided with a spacing between about 2 millimeters and about 33 millimeters in some embodiments. Photonic integrated circuits may also extend past an end surface of a substrate by some distance so that the photonic integrated circuits may more easily interact with a connector. In some embodiments, this distance may be between about 1 millimeter and about 10 millimeters.

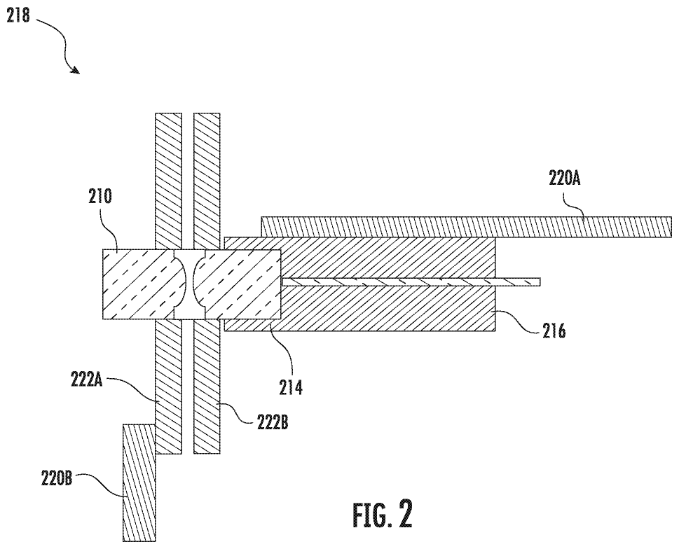

Maintaining appropriate alignment is important for an expanded beam connection approach, and FIG. 2 illustrates one example assembly using alignment techniques for controlling the alignment of an assembly using an expanded beam connection approach. In order to restrict angular offsets, alignment for an assembly 218 may be maintained in one or more principal alignment directions. The wall 220A may serve as a horizontal alignment feature, with the wall 220A extending at least partially along a length of the expanded beam connector 216. The wall 220B may serve as a vertical alignment feature, with the wall 220B extending at least partially along a length of the wall 222A. In other embodiments, a vertical alignment feature such as a wall may extend at least partially along a length of the wall 222B. However, alignment features may be provided in other forms such as with fasteners, brackets, etc. Wall 220A or wall 220B may be provided by one or more components in an assembly such as an extended front plate of a connector, a receptacle, or another component. By maintaining this alignment, the PIC micro lens array 210 and the FAU micro lens array 214 may be properly aligned so that they properly form a beam therebetween. While FIG. 2 illustrates an example where alignment is maintained in two different directions that are perpendicular to each other, alignment may be maintained in other directions in other embodiments.

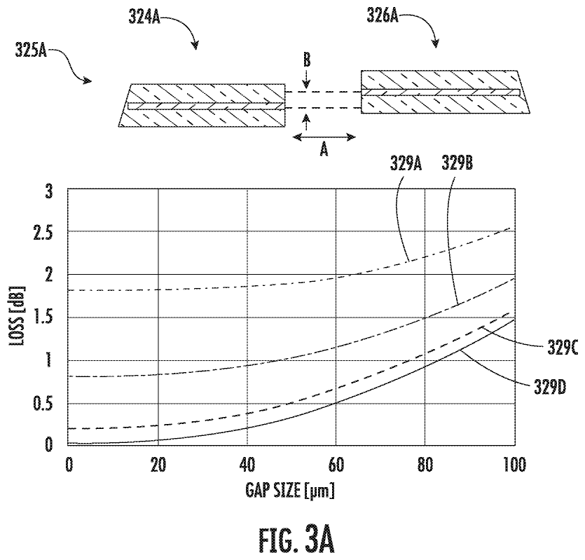

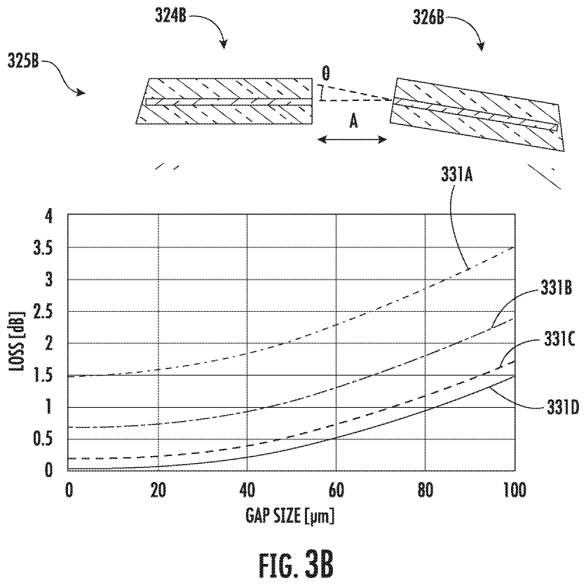

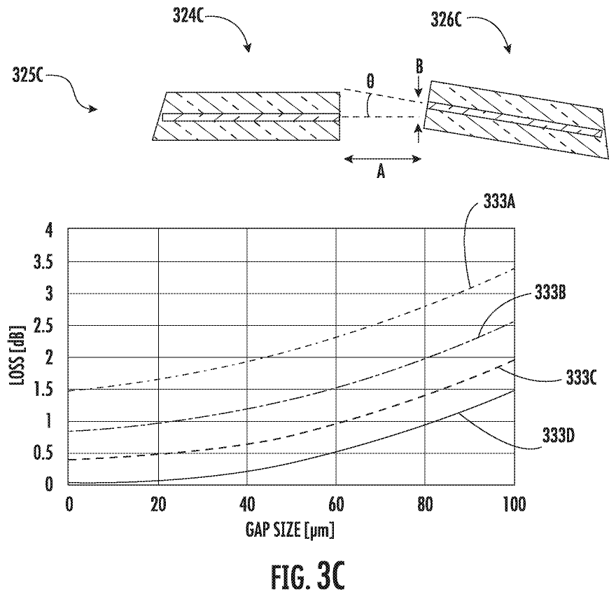

Single mode waveguide assemblies may be coupled together with differing coupling losses depending on the size of a gap between the single mode waveguide assemblies, the lateral offset B between the single mode waveguide assemblies, and the angular offset ⊖ between the single mode waveguide assemblies. FIGS. 3A-3C illustrate the impact on coupling loss when differing values are used for the gap size A, the lateral offset B, and the angular offset ⊖.

FIG. 3A illustrates a graph showing coupling loss for an arrangement of single mode waveguide assemblies having a gap and a lateral offset between single mode waveguide assemblies, with the arrangement having an angular offset ⊖ of about zero degrees. The arrangement 325A for single mode waveguide assemblies 324A, 326A is illustrated at the top of FIG. 3A. The single mode waveguide assemblies 324A, 326A may be separated from each other by a gap having a gap size A, and the single mode waveguide assemblies 324A, 326A may be laterally offset from each other by a lateral offset B. In the graph of FIG. 3A, the amount of coupling loss is illustrated on the Y-axis in decibels, and the gap size is illustrated on the X-axis in micrometers. For the first plotline 329A, the lateral offset B was about three micrometers. Additionally, the lateral offset B was about two micrometers for the second plotline 329B, the lateral offset B was about one micrometer for the third plotline 329C, and the lateral offset B was about zero micrometers for the fourth plotline 329D. The waveguides of the single mode waveguide assemblies 324A, 326A correspond to single mode fibers, and the waveguides in each of the single mode waveguide assemblies 324A, 326A had identical dimensions. Additionally, the gap between the single mode waveguide assemblies 324A, 326A was filled with index matching gel having an n-value of about 1.4, and the waveguides operated at a wavelength of about 1.31 micrometers.

The results illustrated in the graph of FIG. 3A show that, regardless of the lateral offset amount, the amount of the coupling loss increased as the gap size increased. Furthermore, the amount of coupling loss increased at greater rates as the gap size increased. For example, the increase in the amount of coupling loss when the gap size was increased from zero micrometers to twenty micrometers was less than the increase in the amount of coupling loss when the gap size was increased from 80 micrometers to 100 micrometers.

Additionally, the results illustrated in the graph of FIG. 3A show that the amount of coupling loss increased as the lateral offset increased. When the plotlines 329A-329D are compared at each gap size, the fourth plotline 329D (which had the lowest lateral offset B at zero micrometers) had the lowest amount of coupling loss, the third plotline 329C had the second lowest amount of coupling loss, the second plotline 329B had the third lowest amount of coupling loss, and the first plotline 329A had the most amount of coupling loss. For the graph illustrated in FIG. 3A, it is assumed that Fresnel losses are negligible.

FIG. 3B illustrates a graph showing coupling loss for an arrangement of single mode waveguide assemblies having a gap and an angular offset between single mode waveguide assemblies, with the lateral offset being about zero micrometers. The arrangement 325B for waveguide assemblies 324B, 326B is illustrated at the top of FIG. 3B. The single mode waveguide assemblies 324B, 326B may be separated from each other by a gap having a gap size A, and the single mode waveguide assemblies 324B, 326B may be angularly offset from each other by an angular offset ⊖. The waveguides of the single mode waveguide assemblies 324B, 326B correspond to single mode fibers, and the waveguides in each of the single mode waveguide assemblies 324B, 326B had identical dimensions. Additionally, the gap between the waveguide assemblies 324B, 326B was filled with index matching gel having an n-value of about 1.4, and the waveguides operated at a wavelength of about 1.31 micrometers.

In the graph of FIG. 3B, the amount of coupling loss is illustrated on the Y-axis in decibels, and the gap size A is illustrated on the X-axis in micrometers. For the first plotline 331A, the angular offset ⊖ was about three degrees. Additionally, the angular offset ⊖ was about two degrees for the second plotline 331B, the angular offset ⊖ was about one degree for the third plotline 331C, and the angular offset ⊖ was about zero for the fourth plotline 331D.

The results illustrated in the graph of FIG. 3B show that, regardless of the angular offset ⊖ amount, the amount of the coupling loss increased as the gap size A increased. Furthermore, the amount of coupling loss increased at greater rates as the gap size A increased. For example, the increase in the amount of coupling loss when the gap size A was increased from zero micrometers to twenty micrometers was less than the increase in the amount of coupling loss when the gap size was increased from 80 micrometers to 100 micrometers.

Additionally, the results illustrated in the graph of FIG. 3B show that the amount of coupling loss increased as the angular offset ⊖ increased. When the plotlines 331A-331D are compared at each gap size, the fourth plotline 331D (which had the lowest angular offset ⊖ at zero degrees) had the lowest amount of coupling loss, the third plotline 331C had the second lowest amount of coupling loss, the second plotline 331B had the third lowest amount of coupling loss, and the first plotline 331A had the most amount of coupling loss. For the graph illustrated in FIG. 3B, it is assumed that Fresnel losses are negligible.

FIG. 3C illustrates a graph showing coupling loss for an arrangement of single mode waveguide assemblies having a gap, a lateral offset, and an angular offset between single mode waveguide assemblies. The arrangement 325C for single mode waveguide assemblies 324C, 326C is illustrated at the top of FIG. 3C. The single mode waveguide assemblies 324C, 326C may be separated from each other by a gap having a gap size A, the single mode waveguide assemblies 324C, 326C may be laterally offset from each other by a lateral offset B, and the single mode waveguide assemblies 324C, 326C may be angularly offset from each other by an angular offset ⊖. The waveguides of the single mode waveguide assemblies 324C, 326C correspond to single mode fibers, and the waveguides in each of the single mode waveguide assemblies 324C, 326C had identical dimensions. Additionally, the gap between the single mode waveguide assemblies 324C, 326C was filled with index matching gel having an n-value of about 1.4, and the waveguides operated at a wavelength of about 1.31 micrometers.

In the graph of FIG. 3C, the amount of coupling loss is illustrated on the Y-axis in decibels, and the gap size A is illustrated on the X-axis in micrometers. For the first plotline 333A, the angular offset ⊖ was about two degrees and the lateral offset B was about two micrometers. For the second plotline 333B, the angular offset ⊖ was about 1.5 degrees and the lateral offset B was about 1.5 micrometers. For the third plotline 333C, the angular offset ⊖ was about one degree and the lateral offset B was about one micrometer. For the fourth plotline 333D, the angular offset ⊖ was about zero degrees and the lateral offset B was about zero micrometers.

The results illustrated in the graph of FIG. 3C show that the amount of the coupling loss increased as the gap size A increased. Furthermore, the amount of coupling loss increased at greater rates as the gap size increased. For example, the increase in the amount of coupling loss when the gap size was increased from zero micrometers to twenty micrometers was much less than the increase in the amount of coupling loss when the gap size was increased from 80 micrometers to 100 micrometers.

Additionally, the results illustrated in the graph of FIG. 3C show that the amount of coupling loss increased as the angular offset and the lateral offset increased. When the plotlines 333A-333D are compared at each gap size, the fourth plotline 331D had the lowest amount of coupling loss, the third plotline 331C had the second lowest amount of coupling loss, the second plotline 331B had the third lowest amount of coupling loss, and the first plotline 331A had the most amount of coupling loss. For the graph illustrated in FIG. 3B, it is assumed that Fresnel losses are negligible. For each of the results illustrated in the graphs of FIGS. 3A-3C, the mode field diameter (MFD) has a size of about 9.3 micrometers.

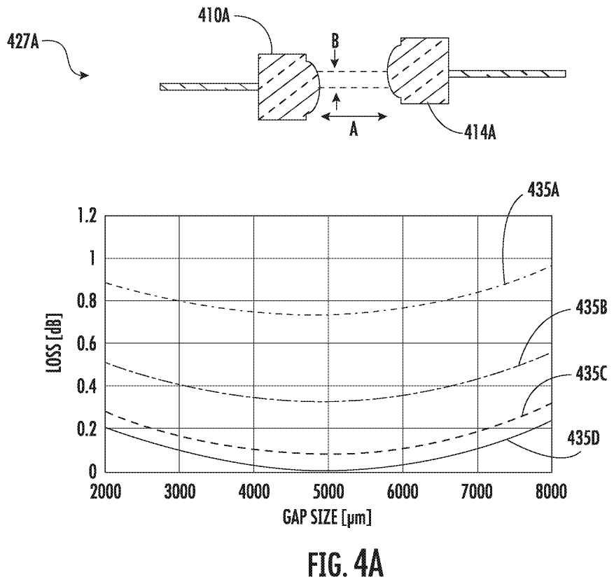

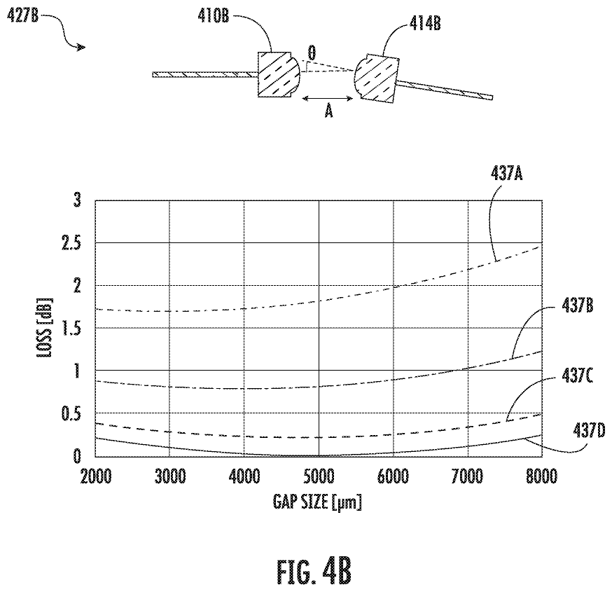

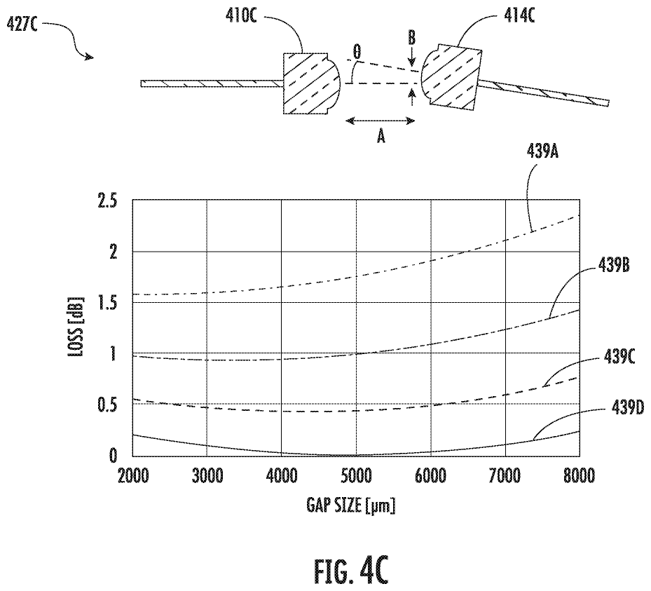

Micro lens arrays may also be coupled together with differing coupling losses depending on the gap size A between the micro lens arrays, the lateral offset B between the micro lens arrays, and the angular offset ⊖ between the micro lens arrays. FIGS. 4A-4C illustrate the impact on coupling loss when differing values are used for the gap size A, the lateral offset B, and the angular offset ⊖.

FIG. 4A illustrates a graph showing coupling loss for an arrangement having a gap size A and a lateral offset B between micro lens arrays, with the angular offset ⊖ being about zero degrees. The arrangement 427A for a first micro lens array 410A and a second micro lens array 414A is illustrated at the top of FIG. 4A. The micro lens arrays 410A, 414A may be separated from each other by a gap size A, and the micro lens arrays 410A, 414A may be laterally offset from each other by a lateral offset B. In the graph of FIG. 4A, the amount of coupling loss is illustrated on the Y-axis in decibels, and the gap size is illustrated on the X-axis in micrometers. For the first plotline 435A, the lateral offset was about 30 micrometers. Additionally, the lateral offset was about twenty micrometers for the second plotline 435B, the lateral offset was about ten micrometers for the third plotline 435C, and the lateral offset was about zero micrometers for the fourth plotline 435D. For the graph illustrated in FIG. 4A, it is assumed that Fresnel losses are negligible. Additionally, the micro lens arrays 410A, 414A were positioned in air with air having an n-value of about 1, and the micro lens arrays 410A, 414A operated at a wavelength of about 1.31 micrometers. The micro lens arrays 410A, 414A were also identical to each other.

The results illustrated in the graph of FIG. 4A show that, regardless of the lateral offset amount, the amount of the coupling loss was lowest at a gap size of about 5000 micrometers. For example, the first plotline 435A was at about 0.73 decibels when the gap size was around 5000 micrometers, and the first plotline 435 showed a coupling loss of about 0.9 decibels at a gap size of 2000 micrometers and a coupling loss of about 0.95 decibels at a gap size of 8000 micrometers.

Additionally, the results illustrated in the graph of FIG. 4A show that the amount of coupling loss increased as the lateral offset increased. When the plotlines 435A-435D are compared at each gap size, the fourth plotline (which had the lateral offset of about zero micrometers) had the lowest amount of coupling loss. The third plotline had the second lowest amount of coupling loss, the second plotline had the third lowest amount of coupling loss, and the first plotline had the most amount of coupling loss.

FIG. 4B illustrates a graph showing coupling loss for an arrangement having a gap and an angular offset between micro lens arrays, with the lateral offset B being about zero micrometers. The arrangement 427B for a first micro lens array 410B and a second micro lens array 414B is illustrated at the top of FIG. 4B. The micro lens arrays 410B, 414B may be separated from each other by a gap having a gap size A, and the micro lens arrays 410A, 414A may be angularly offset from each other by an angular offset ⊖. In the graph of FIG. 4B, the amount of coupling loss is illustrated on the Y-axis in decibels, and the gap size is illustrated on the X-axis in micrometers. For the first plotline 437A, the angular offset ⊖ was about 0.3 degrees. Additionally, the angular offset ⊖ was about 0.2 degrees for the second plotline 437B, the angular offset ⊖ was about 0.1 degrees for the third plotline 437C, and the angular offset ⊖ was about 0 degrees for the fourth plotline 437D. For the graph illustrated in FIG. 4B, it is assumed that Fresnel losses are negligible. Additionally, the micro lens arrays 410B, 414B were positioned in air with air having an n-value of about 1, and the micro lens arrays 410B, 414B operated at a wavelength of about 1.31 micrometers. The micro lens arrays 410B, 414B were also identical to each other.

For the first plotline 437A, the results illustrated in the graph of FIG. 4B show the coupling loss was lowest at a gap size of about 3000 micrometers, with the coupling loss at around 1.7 decibels when the gap size was around 3000 micrometers. For the second plotline 437B, the coupling loss was lowest at a gap size of about 4000 micrometers, with the coupling loss at around 0.75 decibels when the gap size was around 4000 micrometers. For the third plotline 437C, the coupling loss was lowest at a gap size of about 4900 micrometers, with the coupling loss at around 0.2 decibels when the gap size was around 4900 micrometers. For the fourth plotline 437D, the coupling loss was lowest at a gap size of about 5000 micrometers, with the coupling loss at around zero decibels when the gap size was around 5000 micrometers. Thus, as the angular offset ⊖ increased, different gap sizes became optimal to minimize the coupling loss.

Additionally, the results illustrated in the graph of FIG. 4B show that the amount of coupling loss increased as the angular offset increased. When the plotlines 437A-437D are compared at each gap size, the fourth plotline (which had the angular offset ⊖ of about zero degrees) had the lowest amount of coupling loss. The third plotline had the second lowest amount of coupling loss, the second plotline had the third lowest amount of coupling loss, and the first plotline had the most amount of coupling loss.

FIG. 4C illustrates a graph showing coupling loss for an arrangement having a gap, an angular offset, and a lateral offset between micro lens arrays. The arrangement 427C for a first micro lens array 410C and a second micro lens array 414C is illustrated at the top of FIG. 4C. The micro lens arrays 410C, 414C may be separated from each other by a gap having a gap size A, the micro lens arrays 410C, 414C may be laterally offset from each other by a lateral offset B, and the micro lens arrays 410C, 414C may be angularly offset from each other by an angular offset ⊖. In the graph of FIG. 4C, the amount of coupling loss is illustrated on the Y-axis in decibels, and the gap size is illustrated on the X-axis in micrometers. For the first plotline 439A, the angular offset ⊖ was about 0.2 degrees and the lateral offset B was about 20 micrometers. For the second plotline 439B, the angular offset ⊖ was about 0.15 degrees and the lateral offset B was about 15 micrometers. For the third plotline 439C, the angular offset ⊖ was about 0.1 degrees and the lateral offset B was about 10 micrometers. For the fourth plotline 439D, the angular offset ⊖ was about zero degrees and the lateral offset B was about zero micrometers. For the graph illustrated in FIG. 4C, it is assumed that Fresnel losses are negligible. Additionally, the micro lens arrays 410C, 414C were positioned in air with air having an n-value of about 1, and the micro lens arrays 410C, 414C operated at a wavelength of about 1.31 micrometers. The micro lens arrays 410C, 414C were also identical to each other.

For the first plotline 439A, the results illustrated in the graph of FIG. 4C show the coupling loss was lowest at a gap size of about 2000 micrometers, with the coupling loss at around 1.6 decibels when the gap size was around 2000 micrometers. For the second plotline 439B, the coupling loss was lowest at a gap size of about 3500 micrometers, with the coupling loss at around 0.9 decibels when the gap size was around 3500 micrometers. For the third plotline 439C, the coupling loss was lowest at a gap size of about 4500 micrometers, with the coupling loss at around 0.4 decibels when the gap size was around 4500 micrometers. For the fourth plotline 439D, the coupling loss was lowest at a gap size of about 5000 micrometers, with the coupling loss at around zero decibels when the gap size was around 5000 micrometers. Thus, as the angular offset ⊖ and lateral offset B increased, different gap sizes became optimal to minimize the coupling loss. This is believed to be attributable to the change in angular offset ⊖.

Additionally, the results illustrated in the graph of FIG. 4C show that the amount of coupling loss increased as the angular offset increased. When the plotlines 439A-439D are compared at each gap size, the fourth plotline (which had the angular offset ⊖ of about zero degrees) had the lowest amount of coupling loss. The third plotline had the second lowest amount of coupling loss, the second plotline had the third lowest amount of coupling loss, and the first plotline had the most amount of coupling loss.

The expanded beam connector may be efficiently made relative to other potential solutions using relay optics. Expanded beam connector solutions may have relaxed lateral and axial alignment tolerances, and Fresnel losses may be minimized for expanded beam connector solutions. Expanded beam connector solutions may also have some drawbacks. For example, expanded beam connector solutions may have two micro lens arrays while other solutions may have only one micro lens array. Expanded beam connector solutions often have four different active alignment steps, but the tolerances for most of these alignment steps are typically simple to accomplish. Expanded beam connector solutions may also have strict tolerances for angular alignment, with these solutions being sensitive to angular misalignment, but other tolerances are more relaxed.

Where an existing solution is used with relay optics positioned on the silicon photonic assembly side of the connection separation line (a “PIC side relay optic solution”), the overall level of risks tends to be higher than when an expanded beam connector solution is used. For PIC side relay optic solutions, it may be difficult for manufacturers to measure the quality of connectors. The PIC side relay optic solution relies upon index matching gel. PIC side relay optic solutions often have only one micro lens array, and Fresnel losses may be minimized similar to expanded beam connector solutions. PIC side relay optic solutions may also have multiple active alignment steps.

Where an existing solution is used with relay optics positioned on the connector side of the connection separation line (a “connector side relay optic solution”), the overall level of risks tends to be higher than when an expanded beam connector solution is used. For the connector side relay optic solution, higher Fresnel losses are frequently obtained and typically may not be avoided. Connector side relay optic solutions may also have three or more active alignment steps. Connector side relay optic solutions often have only one micro lens array, and a connector manufacturer often is able to fully control active alignment of micro lens arrays for connector side relay optic solutions. Another downside of connector side relay optic solutions is the difficulty of aligning receptacles with photonic integrated circuits. The connector side relay optic solution may also have limited interchangeability for connectors.

An expanded beam connector may have more relaxed tolerances for lateral offset relative to other potential solutions using relay optics, with expanded beam connectors having tolerances of ten micrometers or more while relay optics tend to have tighter tolerances of less than ten micrometers. Similarly, an expanded beam connector may have a relaxed tolerance for axial alignment, with expanded beam connectors having tolerances of ten micrometers or more while relay optics tend to have tighter tolerances of less than ten micrometers. Expanded beam connectors tend to have tighter tolerances for angular alignment relative to other PIC side relay optic solutions-expanded beam connectors have tolerances of less than 1 degree while the PIC side relay optic solution has an angular tolerance of 1 degree or more. Where connector side relay optic solutions are used, the angular tolerances are similar to the angular tolerances for expanded beam connectors. These tolerance values are summarized in Table 1.

TABLE 1
Tolerance Evaluation for Expanded Beam Solutions

| Required Connector | Expanded Beam | PIC Side Relay Optic | Connector Side Relay |
|---|---|---|---|
| Alignment Precision | Connector Solution | Solution | Optic Solution |
| Lateral Tolerance | 10's of micrometers | 1's of micrometers | 1's of micrometers |
| Axial Tolerance | 100's of micrometers | 10's of micrometers | 10's of micrometers |
| Angular Tolerance | 0.1's of degrees | 1's of degrees | 0.1's of degrees |

The values obtained for the tolerances discussed above are obtained based on several assumptions. First, it was assumed that photonic integrated circuit optics were optimally aligned with photonic integrated circuit waveguides and fixed with respect to waveguide position. Thus, it was assumed that the receptacle did not have any lateral or angular misalignment. Second, it was assumed that the connector, the micro lens array associated with the connector, and the fibers may have lateral and angular offset with respect to the receptacle, the photonic integrated circuit optics, and the associated waveguides.

In some embodiments, expanded beam connector solutions may have three different anti-reflection (AR) coated surfaces. PIC side relay optic solutions may also have three different AR coated surfaces, and connector side relay optic solutions may have only one AR coated surface. In some embodiments, expanded beam connector solutions may have two different types of AR coatings. PIC side relay optic solutions may also have two different types of AR coatings, but connector side relay optic solutions may have only one type of AR coating. In some embodiments, expanded beam connector solutions may allow for the use of index matching gel. PIC side relay optic solutions may also allow for the use of index matching gel, but connector side relay optic solutions typically do not allow for the use of index matching gel. In some embodiments, expanded beam connector solutions may have low Fresnel losses between around 0.004 decibels and around 0.01 decibels. PIC side relay optic solutions may also have Fresnel losses of around 0.004 decibels and around 0.01 decibels. However, connector side relay optic solutions have Fresnel losses of around 0.12 decibels, with the effective refractive index of waveguides being about 1.4 for these solutions. These design features are summarized in Table 2 alongside other solutions using relay optics.

TABLE 2
Other Design Features for Expanded Beam Solutions Compared

| | Expanded Beam | PIC Side | Connector |
|---|---|---|---|
| Required Connector | Connector | Relay Optic | Side Relay |
| Alignment Precision | Solution | Solution | Optic Solution |
| Number of AR | 3 | 3 | 1 |
| Coated Surfaces | | | |
| Number of Different | 2 | 2 | 1 |
| AR Coatings | | | |
| Index Matching Gel | Yes | Yes | No |
| Possible? | | | |
| Fresnel Losses | 0.004-0.01 | 0.004-0.01 | 0.12 |
| (decibels) | | | |

The values obtained for the design criteria discussed above are obtained based on several assumptions. First, it is assumed that micro lens arrays and fibers may be coated with AR coating. Second, it is assumed that waveguides of photonic integrated circuits may not be coated with AR coating. Third, it is assumed that grooves of the photonic integrated circuit may be filled with index matching gel if a micro lens array is attached to the photonic integrated circuit. Fourth, it is assumed that interfaces facing towards index matching gel have a different type of AR coating than interfaces facing towards open air.

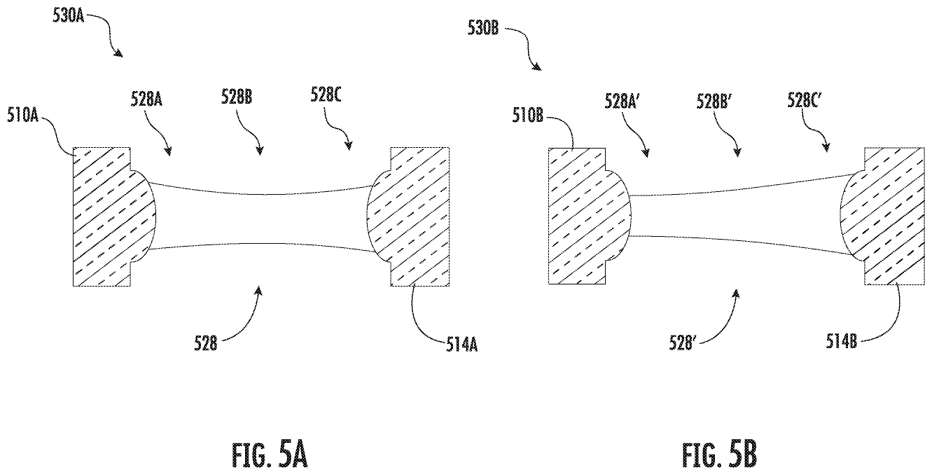

In some embodiments, assemblies may be designed so that beams emitted between micro lens arrays are symmetrical in shape. FIG. 5A is a schematic view illustrating an example of arrangement 530A of micro lens arrays where a beam 528 is formed that is symmetrical. The arrangement 530A includes an emitting micro lens array 510A and a receiving micro lens array 514A. A beam 528 is emitted between the emitting micro lens array 510A and the receiving micro lens array 514A, with this beam 528 being symmetrical. This beam 528 is emitted from an emitting end 528A to a receiving end 528C. The beam 528 may have a reduced thickness at a waist 528B, with this waist 528B being positioned between the emitting end 528A and the receiving end 528C. Where the beam 528 is symmetrical, the diameter of the beam 528 may be identical at the emitting end 528A and the receiving end 528C. Where the beam 528 is symmetrical, the coupling losses in both directions may be about the same. In some embodiments, the optical connection of the arrangement 530A may be bi-directional, and the micro lens arrays 510A, 514A may both be capable of emitting and receiving a beam.

FIG. 5B illustrates an example of arrangement 530B of micro lens arrays where a beam 528′ is formed that is asymmetrical. The arrangement 530B includes an emitting micro lens array 510B and a receiving micro lens array 514B. The beam 528′ is emitted between the emitting micro lens array 510B and the receiving micro lens array 514B. This beam 528′ is emitted from an emitting end 528A′ to a receiving end 528C′. Rather than having a waist like the symmetrical beam of FIG. 5A, the beam 528′ has a central portion 528B′ with an increased diameter relative to the diameter at the emitting end 528A′, and the central portion 528B′ has a reduced diameter relative to the diameter at the receiving end 528C′. Where the beam 528′ is asymmetrical as illustrated, the coupling losses in both directions may be different from each other. The maximum distance between the micro lens arrays 510, 514B may be restricted by the beam diameter because beams with small diameters often suffer from more diffraction than beams with larger diameters.

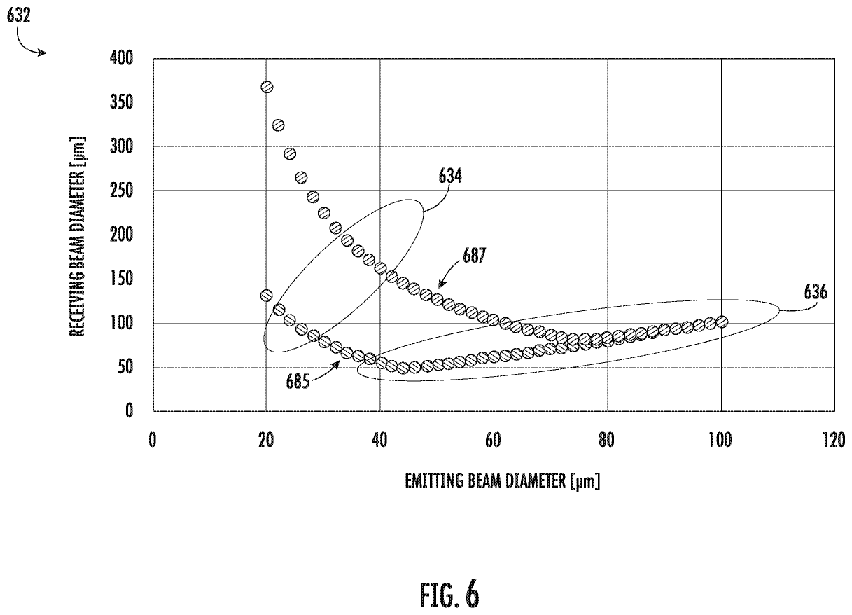

FIG. 6 is a graph 632 illustrating the receiving beam diameter of a beam at a receiving micro lens array as a function of the emitting beam diameter of the same beam at an emitting micro lens array. The graph also illustrates the impact of using different gap sizes. The first set of datapoints 685 represents data when a gap size of 1500 micrometers was used, and the second set of datapoints 687 represents data when a gap size of 4000 micrometers was used. Where the emitting beam diameter is smaller, the beams tend to expand due to diffraction and may not be imaged properly at the receiving micro lens array. Where the emitting beam diameter is larger, the beams tend to be imaged properly at the receiving micro lens array, and the emitting beam diameter tends to be identical to the receiving beam diameter.

For the first set of datapoints 685, the receiving beam diameter tends to decrease as the emitting beam diameter is increased from 20 micrometers to about 45 micrometers, and the beams were asymmetrical where the emitting beam diameter fell in this range (e.g., in the area 634). However, as the emitting beam diameter is increased from about 45 micrometers to larger diameters for the first set of datapoints 685, the beams become symmetrical so that the receiving beam diameter stays about the same as the emitting beam diameter.

For the second set of datapoints 687, the receiving beam diameter tends to decrease as the emitting beam diameter is increased from 20 micrometers to about 80 micrometers, and the beams were asymmetrical where the emitting beam diameter fell in this range. However, as the emitting beam diameter is increased from about 80 micrometers to larger diameters for the second set of datapoints 687 (e.g., in the area 636), the beams become symmetrical so that the receiving beam diameter stays about the same as the emitting beam diameter. At emitting beam diameters of less than about 80 micrometers, the second set of datapoints 687 had higher receiving beam diameters than the first set of datapoints 685. However, at emitting beam diameters of greater than or equal to about 80 micrometers, the receiving beam diameters were about the same for the first set of datapoints 685 and the second set of datapoints 687. The emitting beam diameter may be optimized for the lateral and angular tolerances of a given assembly.

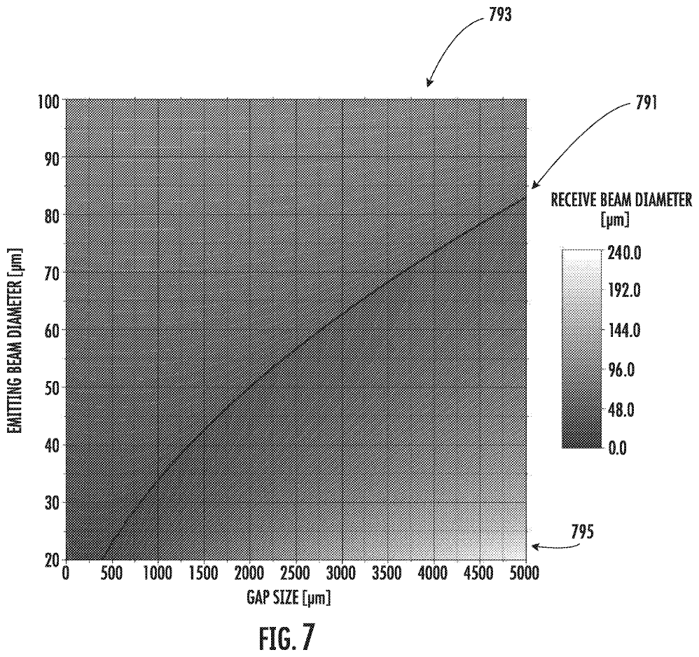

FIG. 7 illustrates the receiving beam diameters received at a second micro lens array when different emitting beam diameters are used at a first micro lens array and when various gap sizes are used between the first micro lens array and the second micro lens array. The receiving beam diameters received at the second micro lens array are illustrated by the gradient in FIG. 7, with these beam diameters ranging from 0.0 micrometers to 240.0 micrometers. For example, the lowest receiving beam diameter of about 0.0 micrometers occurs for an emitting beam diameter of about 20 micrometers and a gap size of zero while the highest receiving beam diameter of about 240.0 micrometers occurs for an emitting beam diameter of about 20 micrometers and a gap size of about 5000 micrometers.

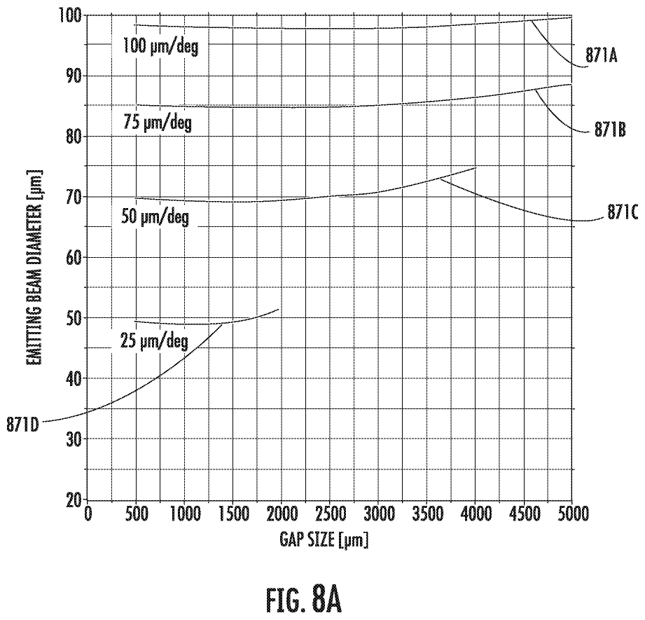

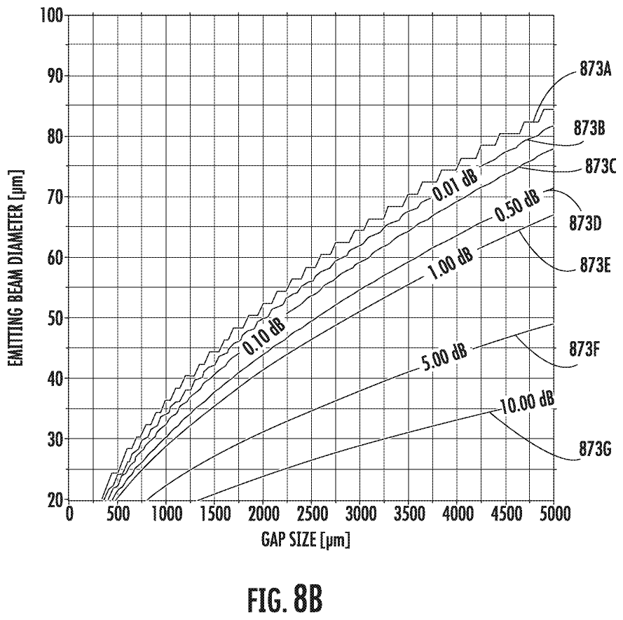

To ensure that a symmetrical beam is formed, an assembly may be designed so that the gap size does not exceed a maximum allowable gap size for each beam diameter. In FIG. 7, the plotline 791 illustrates a design guideline for the minimum beam diameter required at various gap sizes to accomplish a symmetrical expanded beam connector. Where the emitting beam diameter is known, a gap size may be used that is less than or equal to the maximum allowable gap size presented on the plotline 791 for that emitting beam diameter. For example, where the emitting beam diameter is 30 micrometers, a gap size may be selected that is less than or equal to about 750 micrometers. Alternatively, where the gap size is known, an emitting beam diameter may be used that is greater than the minimum beam diameter presented on the plotline 791 for that gap size. For example, where the gap size is known to be 3500 micrometers, the emitting beam diameter may be set to be about 70 micrometers or more. At areas 795 below the plotline 791, the receiving beam diameters tended to be higher or even significantly higher than the emitting beam diameter, with the receive diameter being as high as 459.0 micrometers in some locations. When in the area 795, an increased risk of mismatches between the emitting beam diameter and the receiving beam diameter is present, which may lead to increased coupling losses. However, at areas 793 above the plotline 791 (or to the left of the plotline 791), the receiving beam diameter is about the same as the emitting beam diameter. While FIG. 7 serves as a guide for forming symmetric expanded beam connections, micro lens arrays may also be optimized to provide low coupling losses for asymmetric beams.

Where expanded beam connection approaches are used, angular offset between micro lens arrays may have a significant impact on coupling losses, making it important to effectively limit the amount of angular offset. FIG. 8A is a graph illustrating the ratio between angular and lateral offsets required to cause the same amount of coupling loss. The emitting beam diameter may be optimized for the lateral and angular tolerances of a given assembly. As larger emitting beam diameters are used, maintaining appropriate angular alignment become increasingly important. At larger emitting beam diameters, even small amounts of angular misalignment may lead to significant amounts of coupling loss. In FIG. 8A, a first plotline 871A, a second plotline 871B, a third plotline 871C, and a fourth plotline 871D are illustrated. Each of the plotlines 871A-871D illustrate the coupling loss where there is one degree of angular offset. For the first plotline 871A, one degree of angular offset creates an equal amount of coupling loss as about 100 micrometers of lateral offset. For the second plotline 871B, one degree of angular offset creates an equal amount of coupling loss as about 75 micrometers of lateral offset. For the third plotline 871C, one degree of angular offset creates an equal amount of coupling loss as about 50 micrometers of lateral offset. For the fourth plotline 871D, one degree of angular offset creates an equal amount of coupling loss as about 25 micrometers of lateral offset.

The ratio between angular and lateral offsets for a certain coupling loss value is largely dependent on the emitting beam diameter and is independent of the actual level of the coupling loss. Also, if the beam diameter is larger than the minimum required beam diameter, then this ratio between angular and lateral offsets is only weakly dependent on the gap size. This means that the emitting beam diameter may be optimized for the actual angular and lateral tolerances of any mechanical embodiment of the connector. If the angular and lateral tolerances of a design are known, the optimum emitting beam diameter for this design can be selected according to FIGS. 8A and 8B.

Additionally, the coupling losses may vary depending on the emitting beam diameter that is utilized as well as the gap size. FIG. 8B is a graph illustrating coupling losses when different beam diameters and gap sizes are used. Various plotlines are illustrated. The first plotline 873A illustrates a design guideline for the minimum emitting beam diameter required at various gap sizes to accomplish a symmetrical expanded beam connector. The second plotline 873B illustrates a line where the coupling loss is 0.01 decibels, the third plotline 873C illustrates a line where the coupling loss is 0.10 decibels, the fourth plotline 873D illustrates a line where the coupling loss is 0.50 decibels, the fifth plotline 873E illustrates a line where the coupling loss is 1.00 decibels, the sixth plotline 873F illustrates a line where the coupling loss is 5.00 decibels, and the seventh plotline 873G illustrates a line where the coupling loss is 10.00 decibels. As illustrated by the plotlines 873B-873G, the amount of coupling losses tends to increase towards the bottom right portion of the graph, with larger mismatches between emitting beam diameters and receiving beam diameters occurring in this region of the graph.

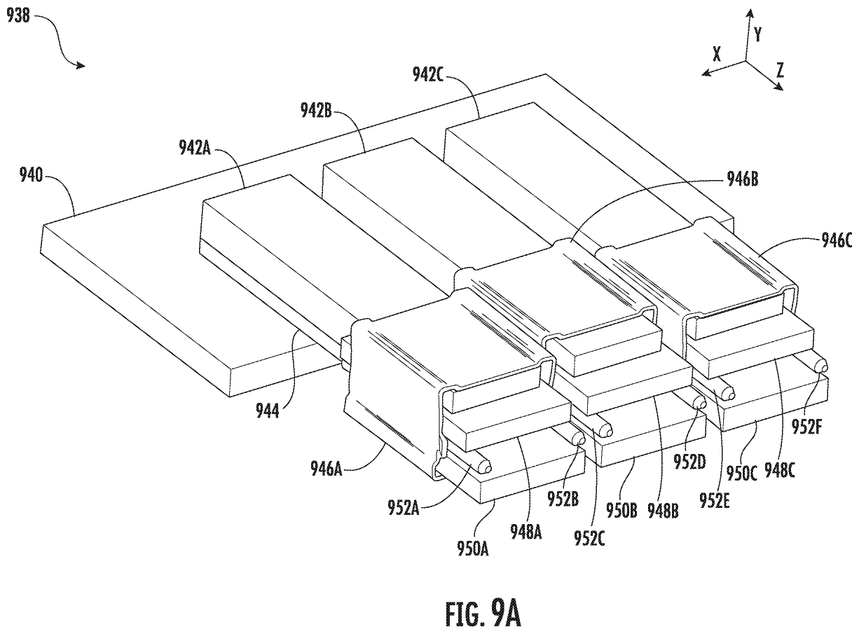

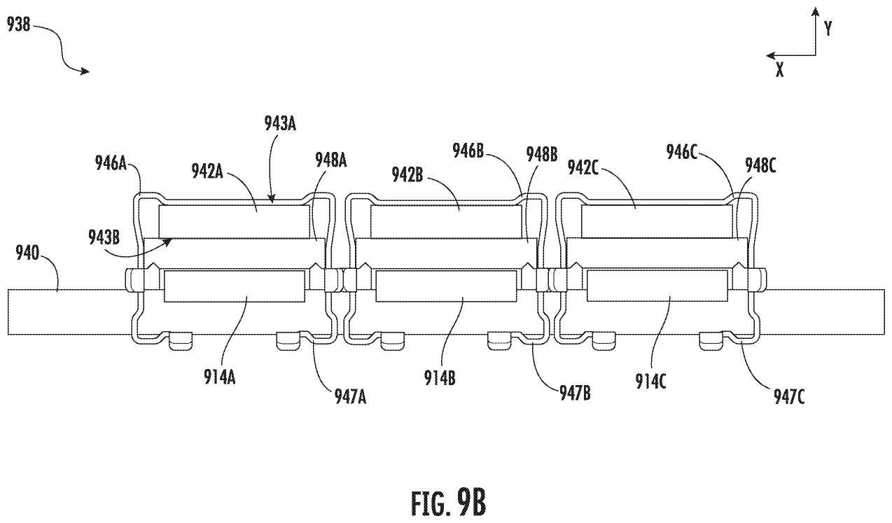

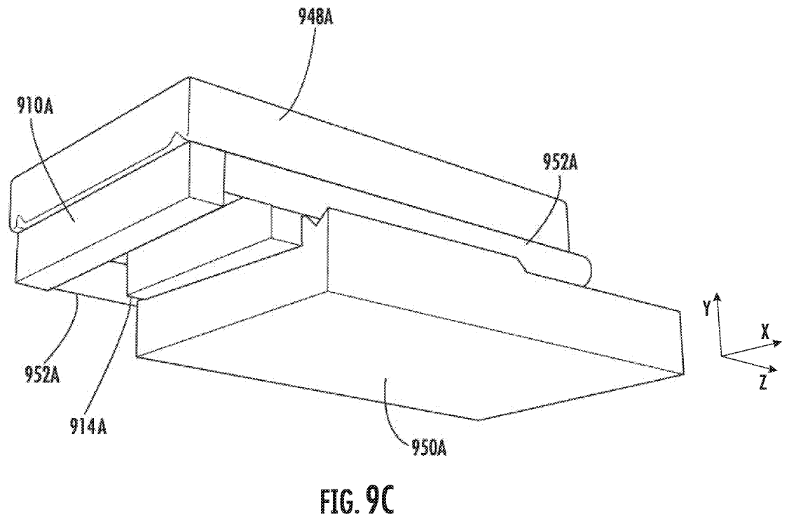

FIG. 9A illustrates an example assembly 938 where alignment features are utilized to maintain alignment of fiber array units, micro lens arrays, receptacles, and a plate. FIG. 9B is a front view illustrating the example assembly 938 of FIG. 9A. The assembly 938 may be used for coupling fiber array units 950A, 950B, 950C to corresponding photonic integrated circuits through expanded beam coupling.

The assembly 938 comprises three photonic integrated circuits, but only photonic integrated circuit 944 is visible in FIG. 9A. The photonic integrated circuit 944 and other photonic integrated circuits may be attached directly or indirectly to a substrate 940. The assembly 938 may also include photonic integrated circuit (PIC) micro lens arrays similar the first micro lens array 910A of FIG. 9C positioned adjacent to each photonic integrated circuits as well as fiber array unit (FAU) micro lens arrays 914A positioned adjacent to each fiber array unit. As illustrated in FIG. 9B, the assembly 938 includes a first PIC micro lens array 910A (see FIG. 9C) attached to the photonic integrated circuit 944. However, the assembly 938 also includes a second PIC micro lens array attached to a second photonic integrated circuit (not shown), and the assembly 938 includes a third PIC micro lens array attached to a third photonic integrated circuit (not shown). The assembly 938 also includes a first FAU micro lens array 914A attached to the first fiber array unit 950A, a second FAU micro lens array 914B attached to the second fiber array unit 950B, and a third FAU micro lens array 914C attached to the third fiber array unit 950C.

For each photonic integrated circuit that is included, there may also be an associated connector that attaches to the photonic integrated circuit. This connector may comprise a fiber array unit, an FAU micro lens array, an alignment feature, a receptacle, and/or a plate, but additional components may be added to these connectors or omitted from these connectors. The assembly 938 includes three fiber array units, including a first fiber array unit 950A, a second fiber array unit 950B, and a third fiber array unit 950C. Each of the fiber array units 950A-950C comprises a plurality of grooves, with each of the grooves being configured to receive at least a portion of a fiber therein. However, in some embodiments, the fiber array units 950A-950C may include only one groove or the fiber array units 950A-950C may be provided without grooves. In some embodiments, the grooves may be provided in the form of V-grooves, but the grooves may take other forms as well. Grooves may be equally spaced from each other in some embodiments so that a common pitch is maintained between the grooves, but the spacing between grooves may be different in other embodiments. The grooves may have the same size, shape, and depth in some embodiments (e.g., each may be provided in the form of a V-grooves having the same depth), but the size, shape, and/or depth of the grooves may be different in other embodiments. The assembly 938 may also include a fiber array unit (FAU) micro lens array attached to the fiber array unit. FAU micro lens arrays 914A, 914B, 914C may be offset from PIC micro lens array by a distance.

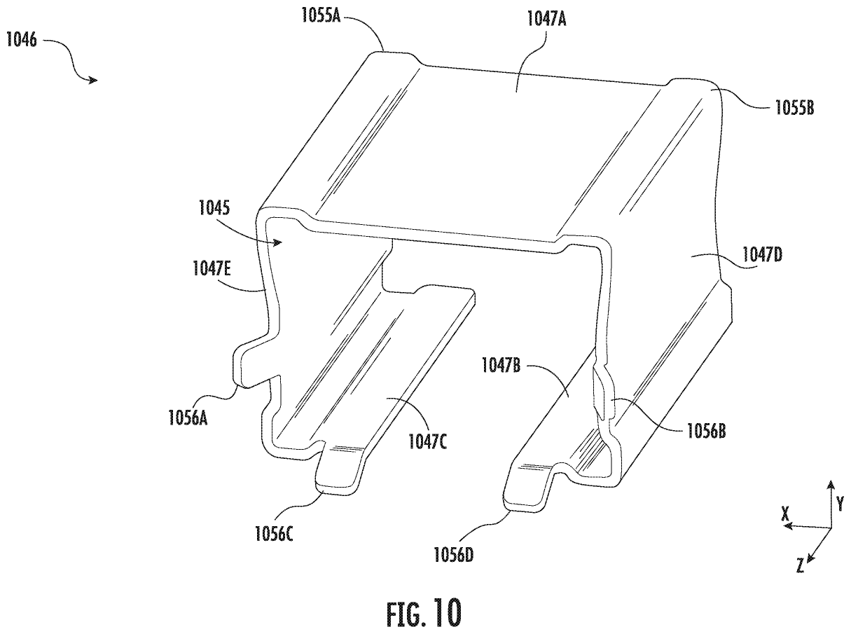

Additionally, the assembly 938 includes various alignment features. These alignment features are configured to control an angular alignment of the FAU micro lens arrays 914A, 914B, 914C relative to PIC micro lens arrays. Additionally, the assembly 938 may include one or more housings, such as housings 946A, 946B, and 946C configured to hold the fiber array units and aid in maintaining a desired angular orientation of the fiber array units relative to respective PIC micro lens arrays. The housing 946A may hold the first fiber array unit 950A such that alignment features 1056C, 1056D (see FIG. 10) are engaged, and the housings 946B, 946C may operate similarly. The housings 946A-946C may provide a sufficient amount of force to prevent accidental movement of the fiber array units 950A-950C. In some embodiments, each of the housings 946A-946C may include a respective latching mechanism to assist in holding the fiber array units 950A-950C or other components of the connector in place.

As illustrated in FIG. 9A, the assembly 938 also comprises a plurality of pins 952A-952F that serve as alignment features. The pins 952A-952F are provided with a cylindrical shape, but the pins 952A-952F may be provided with other shapes in other embodiments. The pins 952A-952F may be manufactured from glass (e.g., large diameter fiber), metal (e.g., MT pins), plastic, or other materials.

Pin 952A and pin 952B may be received within the first housing 946A, and pins 952A-952B may be configured to align the first fiber array unit 950A relative to the receptacle 948A and the first photonic integrated circuit 944. Pin 952C and pin 952D may be received within the second housing 946B, and pins 952C-952D may be configured to align the second fiber array unit 950B relative to the receptacle 948B and the second photonic integrated circuit (not shown). Pin 952E and pin 952F may be received within the third housing 946C, and pins 952E-952F may be configured to align the third fiber array unit 950C relative to the receptacle 948C and the third photonic integrated circuit (not shown). Pins may be partially received within grooves within the fiber array units to help facilitate alignment. For example, pins 952A, 952B may be partially received in grooves of the first fiber array unit 950A, pins 952C, 952D may be partially received in grooves of the second fiber array unit 950B, and pins 952E, 952F may be partially received in grooves of the third fiber array unit 950C. In some embodiments, the receptacles 948A, 948B, 948C may each include grooves, and these grooves may be configured to receive a portion of the pins 952A-952F therein. Receipt of pins 952A-952F within the grooves of the receptacles 948A-948C and within the grooves of the fiber array units 950A-950C may assist in aligning the fiber array units 950A-950C relative to the receptacles 948A-948C so that the fiber array units 950A-950C may also be aligned appropriately relative to photonic integrated circuits. Various grooves described herein may optionally be V-grooves in some embodiments, but grooves may be provided in other forms as well. Grooves may be equally spaced from each other in some embodiments so that a common pitch is maintained between the grooves, but the spacing between grooves may be different in other embodiments. The grooves may have the same size, shape, and depth in some embodiments, but the size, shape, and/or depth of the grooves may be different in other embodiments.

Three different housings 946A-946C are illustrated in FIG. 9A. Each of the housings 946A-946C are configured to maintain positioning of a respective fiber array unit relative to a respective receptacle. For example, the first housing 946A is configured to maintain positioning of a first fiber array unit 950A relative to the first receptacle 948A, the second housing 946B is configured to maintain positioning of a second fiber array unit 950B relative to the second receptacle 948B, and the third housing 946C is configured to maintain positioning of a third fiber array unit 950C relative to the third receptacle 948C. Each of the housings 946A-946C may include retention walls to assist in retaining components within the housings 946A-946C. For example, the first housing 946A may include a retention wall 947A, the second housing 946B may include a retention wall 947B, and the third housing 946C may include a retention wall 947C. Each of these retention walls 947A-947C may come in contact with a respective fiber array unit of fiber array units 950A-950C to assist in maintaining the housings 946A-946C and the components therein in the appropriate positions. However, the housings 946A-946C also include other retention walls as well. The housings 946A-946C may assist in effectively controlling the position of components within the assembly 938 so that the assembly may be provided with high densities. In some embodiments, assemblies may be provided with housings. In order to provide assemblies with higher densities, housings 946A-946C may be staggered relative to each other. For example, as illustrated in FIG. 9A, the second housing 946B is offset in the Z-direction relative to the first housing 946A and the third housing 946C. With this staggering, the housings 946A-946C can be packed more closely together without alignment tabs 1056A, 1056B (see FIG. 10) of different housings interfering with each other.

FIG. 9C is a perspective view illustrating various components of the example assembly 938 of FIG. 9A where the housing is hidden for the purposes of illustration. The assembly may be configured so that an optical beam has about the same diameter at the first PIC micro lens array 910A relative to the diameter at the first FAU micro lens array 914A. In the assembly 938, an expanded beam solution is provided with the first PIC micro lens array 910A and the first FAU micro lens array 914A separated from each other by a distance.

The first PIC micro lens array 910A and the first FAU micro lens array 914A may be positioned proximate to the first receptacle 948A, and other PIC micro lens arrays and FAU micro lens arrays may be positioned similarly relative to other receptacles. A stop may be provided in the assembly 938 to assist in controlling the position of components in directions parallel to the Z-axis. The first PIC micro lens array 910A may serve as the stop, with the pin 952A eventually coming in contact with the first PIC micro lens array 910A to restrict further movement along a direction parallel to the Z-axis. The stop formed by the first PIC micro lens array 910A may assist in maintaining an offset between the first PIC micro lens array 910A and the first FAU micro lens array 914A around the appropriate distance. While the first micro lens array 910A serves as the stop in FIG. 9C, it should be understood that other components may serve as a stop. For example, the first receptacle 948A may have an extended portion extending downwardly along the Y-direction and into the path of the pin 952A, another component may be attached to the first receptacle 948A and/or the micro lens array 910A to serve as a stop, etc. Each PIC micro lens array may be directly attached to a respective photonic integrated circuit 944 (see FIG. 9A), but these PIC micro lens arrays may be attached indirectly to the photonic integrated circuit 944 in some embodiments. Additionally, each FAU micro lens array may be directly attached to a respective first fiber array unit 950A, but these FAU micro lens arrays may be attached indirectly in some embodiments. The first fiber array unit 950A may have one or more grooves provided at a surface of the first fiber array unit 950A, and the groove(s) may be configured to partially receive fibers therein. In some embodiments, the groove(s) are V-grooves. Grooves may be equally spaced from each other in some embodiments so that a common pitch is maintained between the grooves, but the spacing between grooves may be different in other embodiments. The grooves may have the same size, shape, and depth in some embodiments, but the size, shape, and/or depth of the grooves may be different in other embodiments.

The first FAU micro lens array 914A may be attached directly to the first fiber array unit 950A in some embodiments, but the first FAU micro lens array 914A may be indirectly attached to the first fiber array unit 950A using one or more intermediate components in other embodiments. The first receptacle 948A may be aligned with and attached to the photonic integrated circuit 944. The components illustrated in FIG. 9C may be positioned within an internal volume 1045 (see FIG. 10) of the housing 1046 (see FIG. 10), and the housing 1046 may assist in maintaining relative positioning and alignment of the components illustrated in FIG. 9C. The housing 1046 may also help to prevent unwanted movement of components illustrated in FIG. 9C relative to each other. The first receptacle 948A may assist in positioning the micro lens arrays 910A, 914A. For example, the first receptacle 948A may provide a stop for the first fiber array unit 950A to assist in setting the gap size between the two micro lens arrays 910A, 914A. This stop may tend to restrict movement of the first fiber array unit 950A relative to the first receptacle 948A to prevent the first fiber array unit 950A from advancing further along a direction parallel to the Z-axis, and this may cause the position of micro lens arrays 910A, 914A to be set as the micro lens arrays 910A, 914A may be connected, directly or indirectly, to the first fiber array unit 950A and the first receptacle 948A.

In some embodiments, some or all of the receptacles 948A-948C, the fiber array units 950A-950C, the FAU micro lens arrays 914A-914C, and the plates 942A-942C may comprise the same material to minimize effects of a mismatch in coefficient of thermal expansion. However, in some embodiments, different materials may be selected for these components with the materials each having the same or a similar coefficient of thermal expansion.

The assembly 938 includes plates to assist in positioning other components of the assembly. As can be seen in FIG. 9B, the assembly 938 includes a first plate 942A, a second plate 942B, and a third plate 942C. Each of the plates 942A-942C comprises a first surface and a second surface opposite the first surface. For example, the first plate 942A includes a first surface 943A and a second surface 943B opposite the first surface 943A. The plates 942A-942C may be positioned such that the plates come in contact with the housing. For example, the first surface 943A of the first plate 942A may come in contact with retention wall 1047A (see FIG. 10) of the housing 1046 (see FIG. 10), and the retention wall 1047A may optionally be attached to the first plate 942A. However, in some embodiments, the plates 942A-942C may be omitted from an assembly, and the housings 946A-946C may each be positioned so that they are in contact with the receptacles 948A-948C. Where this is the case, the retention wall 1047A of a housing 1046 may optionally be attached to a respective receptacle.

Looking ahead to FIG. 10, further details regarding an example housing 1046 may be seen in greater detail. The housing 1046 comprises a plurality of retention walls. For example, the plurality of retention walls includes a retention wall 1047A, a retention wall 1047B, a retention wall 1047C, a retention wall 1047D, and a retention wall 1047E. Retention wall 1047A is offset from retention wall 1047B and retention wall 1047C by an offset distance. The retention walls 1047B, 1047C are configured to come in contact with a surface on a respective fiber array unit to assist in maintaining positioning of components within the housings. Retention walls 1047B, 1047C may be coplanar in some embodiments, and retention walls 1047B, 1047C may extend in planes that are parallel to a plane defined by retention wall 1047A. Retention walls 1047A-1047C extend in planes that are substantially parallel to the X-Z axis in FIG. 10. Retention walls 1047D, 1047E extend in a different plane relative to retention walls 1047A-1047C, with retention walls 1047D, 1047E extending in planes that are substantially parallel to the Y-Z axis. Retention walls 1047A-1047E may each contact at least one of a plate, a receptacle, or a fiber array unit to assist in controlling alignment. Retention walls 1047A-1047E may each be configured to flex upon the application of force against the retention walls 1047A-1047E, and the retention walls 1047A-1047E may elastically deform during this flexing. The retention walls 1047A-1047E of the housing 1046 may provide sufficient force to appropriately align components within the housing 1046, and the force may engage fine alignment features. The housing 1046 may be configured to receive at least a portion of a plate, a receptacle, and a fiber array unit in the interior volume 1045 of the housing 1046. The housing 1046 may also include corner clearance features 1055A, 1055B, and these corner clearance features 1055A, 1055B may be considered to be retention walls in some embodiments. Corner clearance features 1055A, 1055B may extend between different retention walls and a change in the angle of retention walls occurs at the corner clearance features 1055A, 1055B. The ability of retention walls 1047A-1047E and the corner clearance features 1055A, 1055B to flex may assist in allowing connector components to be easily inserted and retained within the housing 1046. The housing 1046 also includes a plurality of alignment features 1056A, 1056B, 1056C, 1056D. These alignment features 1056A-1056D may assist in providing guidance while inserting a fiber array unit into the housing 1046, with alignment features 1056A, 1056B providing guidance in directions parallel to the X-axis and with alignment features 1056C, 1056D providing guidance in directions parallel to the Y-axis These alignment features 1056A-1056D are provided in the form of tabs that are integrally connected to the remainder of the housing 1046, but other types of alignment features 1056A-1056D are also contemplated.

The housing 1046 may assist in retaining other components and in providing required biasing (e.g., spring) force to stabilize connections. The housing 1046 may be attached to the plate and may provide a robust solution for simple retention. In some embodiments, the housing 1046 may be provided with a low thickness, and the housing 1046 may comprise sheet metal in some embodiments to enable a low thickness. However, the housing 1046 may comprise other suitable materials as well. A low thickness for the housing 1046 may enable use with assemblies having a high density of photonic integrated circuits.

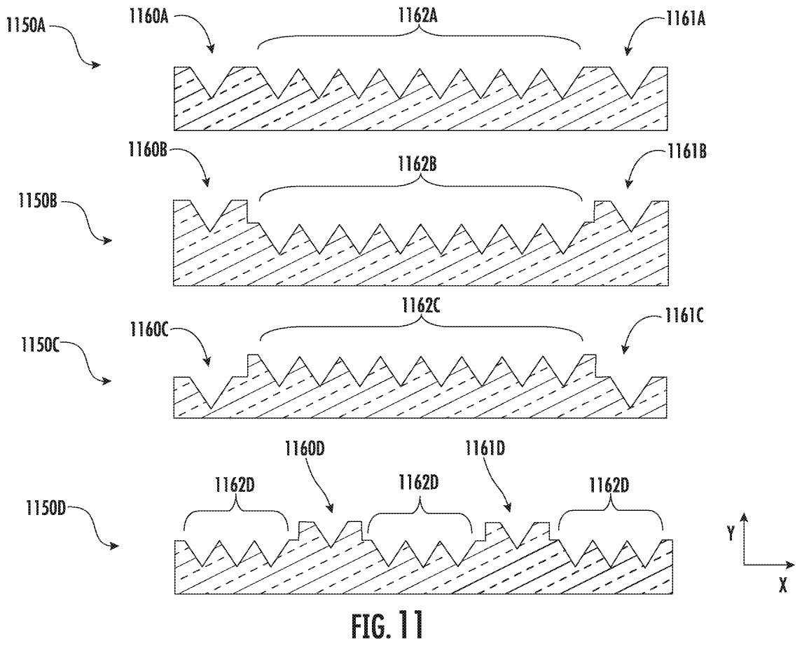

Different types of fiber array units may be used, and some example fiber array units are illustrated in FIG. 11. A first fiber array unit 1150A is illustrated with a first pin groove 1160A and a second pin groove 1161A positioned at opposite ends of the first fiber array unit 1150A. Additionally, a plurality of fiber grooves 1162A are positioned between the pin grooves 1160A, 1161A. In the first fiber array unit 1150A, the pin grooves 1160A, 1161A are positioned at the same level as the fiber grooves 1162A in a direction parallel to the Y-axis.

A second fiber array unit 1150B is illustrated with a first pin groove 1160B and a second pin groove 1161B positioned at opposite ends of the second fiber array unit 1150B. Additionally, a plurality of fiber grooves 1162B are positioned between the pin grooves 1160B, 1161B. In the second fiber array unit 1150B, the pin grooves 1160B, 1161B are positioned at a different level than the fiber grooves 1162B, with the second fiber array unit 1150B having an increased thickness in a direction parallel to the Y-axis at exterior portions where the pin grooves 1160B, 1161B are located.

A third fiber array unit 1150C is illustrated with a first pin groove 1160C and a second pin groove 1161C positioned at opposite ends of the third fiber array unit 1150C. Additionally, a plurality of fiber grooves 1162C are positioned between the pin grooves 1160C, 1161C. In the third fiber array unit 1150C, the pin grooves 1160C, 1161C are positioned at a different level than the fiber grooves 1162C, with the third fiber array unit 1150C having a decreased thickness in a direction parallel to the Y-axis at exterior portions where the pin grooves 1160C, 1161C are located.

A fourth fiber array unit 1150D is illustrated with a first pin groove 1160D and a second pin groove 1161D. Additionally, a plurality of fiber grooves 1162D are positioned at a surface of the fourth fiber array unit 1150D. In the fourth fiber array unit 1150D, some of the fiber grooves 1162D are positioned on opposite ends of the fourth fiber array unit 1150D instead of the pin grooves 1160D, 1161D, and the pin grooves 1160D, 1161D are positioned at locations closer to the center of the surface on the fourth fiber array unit 1150D. In the fourth fiber array unit 1150D, the pin grooves 1160D, 1161D are positioned at a different level in a direction parallel to the Y-axis than the fiber grooves 1162D, with the fourth fiber array unit 1150D having an increased thickness at portions where the pin grooves 1160D, 1161D are located.

In each of the fiber array units 1150A-1150D of FIG. 11, the grooves are V-grooves, but other types of grooves may be used as well. Grooves may be equally spaced from each other in some embodiments so that a common pitch is maintained between the grooves, but the spacing between grooves may be different in other embodiments. The grooves may have the same size, shape, and depth in some embodiments, but the size, shape, and/or depth of the grooves may be different in other embodiments. Additionally, while fiber array units 1150A-1150C include eight fiber grooves and while fiber array unit 1150D includes nine fiber grooves, these fiber array units may include a different number of fiber grooves in other embodiments. While fiber array units 1150A-1150D each include only two pin grooves, these fiber array units 1150A-1150D may include a different number of pin grooves. In some embodiments, each of the fiber grooves may be filled with fibers, but some of the fibers may be left empty or may be filled with objects other than fibers. Each of the pin grooves in the fiber array units 1150A-1150D possess the same geometry, but these pin grooves may be different in size or shape within a single fiber array unit in some embodiments. In some embodiments, the fiber array units may each comprise glass material, but other materials may be used in the fiber array units.

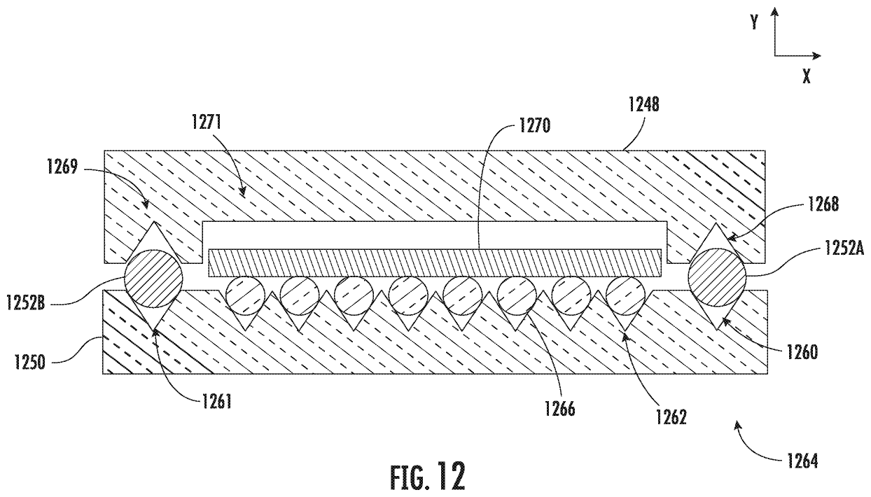

FIG. 12 illustrates an example connector 1264, and this connector may include pins 1252A, 1252B. In some embodiments, the pins 1252A, 1252B may comprise glass material, a fiber material such as a large-diameter fiber, metal, or some other suitable material. In some embodiments, the pins may be mechanically transferable (MT) pins that may be configured to be received within corresponding holes in a ferrule. In some embodiments, dummy fibers, actual fibers, or other objects may be used in place of pins 1252A, 1252B to assist in maintaining alignment. Pins may be provided with a cylindrical shape, but the pins may also have other shapes.

In some embodiments, a lid 1270 may be included in the connector 1264. The lid 1270 may assist in covering fibers 1266 when fibers are positioned in the fiber grooves 1262. The lid 1270 may be positioned so that the lid 1270 is in contact with the fibers 1266 when the fibers are positioned in the fiber grooves 1262 so that the fibers 1266 are positioned by the walls of the fiber grooves 1262 as well as the surface of the lid 1270. Eight fibers 1266 are illustrated in FIG. 12, with each fiber 1266 being positioned in a respective fiber groove 1262. However, a different number of fibers and a different number of fiber grooves 1262 may be included in some embodiments. For example, in some embodiments, five fibers to thirty fibers may be provided in a single connector 1264. In some embodiments, some or all of the fibers 1266 may be polarization maintaining fibers, but some or all of the fibers 1266 may be single mode fibers in other embodiments. The fiber grooves 1262 may be positioned such that the fibers 1266 are separated by a pitch of about 250 micrometers in some embodiments, but this pitch may possess other values (e.g., between about 50 micrometers and about 500 micrometers in some embodiments). The connector 1264 may operate at a wavelength range of between about 1275 nanometers and about 1345 nanometers, or the connector 1264 may even operate at a wavelength range of between about 1300 nanometers to about 1320 nanometers. The connector 1264 may operate in a continuous wave with a maximum power of about 250 megawatts for polarization maintaining fibers in some embodiments. The connector 1264 may be configured to operate at an operating temperature of between about-5 degrees Celsius and about 80 degrees Celsius in some embodiments. The connector 1264 may be re-matable in some embodiments, with the connector 1264 being configured to undergo about 10 or more mating cycles. Connectors 1264 may also be capable of solder reflow. The photonic integrated circuit may go through a solder reflow process, and all parts permanently attached to the photonic integrated circuit may be capable of withstanding this solder reflow process. Connectors 1264 may be provided with an insertion loss target of less than about 2 decibels in some embodiments.

The receptacle 1248 may include two pin grooves 1268, 1269, and the thickness of the receptacle 1248 is greater at the pin grooves 1268, 1269 than at other portions of the receptacle 1248 in a direction parallel to the Y-axis. The number of pin grooves in the receptacle 1248 may match the number of pin grooves in the fiber array unit 1250. A recessed portion 1271 is positioned in the receptacle 1248 between the pin grooves 1268, 1269, and the lid 1270 may be positioned in the recessed portion 1271. However, in other embodiments, the recessed portion 1271 may be omitted so that the receptacle 1248 generally possesses the same thickness throughout the receptacle 1248 (e.g., from left to right in FIG. 12). In other embodiments, the thickness at the pin grooves 1268, 1269 may actually be smaller than the thickness at other portions of the receptacle 1248 so that an enlarged portion is positioned in the receptacle 1248 between the pin grooves 1268, 1269, and this enlarged portion may contact the fibers 1266 to assist in positioning the fibers 1266. In some embodiments, the lid 1270 may be omitted, and the fibers 1266 may come in contact with the receptacle 1248 instead of the lid 1270. In some embodiments, the lid 1270 may completely cover fibers 1266 positioned in grooves on the fiber array unit. However, in other embodiments, the lid 1270 may only partially cover the fibers 1266 positioned in fiber grooves 1262 on the fiber array unit 1250, or a lid 1270 may not cover the fibers 1266 at all (e.g., the lid 1270 may be omitted).

The fiber array unit 1250 includes pin grooves 1260, 1261, and the receptacle 1248 includes pin grooves 1268, 1269. The pin grooves 1260, 1261, 1268, 1269 may be V-grooves in some embodiments, but other types of grooves may be utilized as well. Grooves may be equally spaced from each other in some embodiments so that a common pitch is maintained between the grooves, but the spacing between grooves may be different in other embodiments. The grooves may have the same size, shape, and depth in some embodiments, but the size, shape, and/or depth of the grooves may be different in other embodiments. The pin 1252A may be partially received in the pin groove 1260 of the fiber array unit 1250, and the pin 1252A may also be partially received in the pin groove 1268 of the receptacle 1248. As a result, the pin 1252A may help facilitate alignment between the receptacle 1248 and the fiber array unit 1250. Similarly, the pin 1252B may be partially received in the pin groove 1261 of the fiber array unit 1250 and in the pin groove 1269 of the receptacle 1248. As a result, the pin 1252B may help facilitate alignment between the receptacle 1248 and the fiber array unit 1250.

Various methods of manufacturing an expanded beam coupling assembly are also contemplated in some embodiments herein. FIG. 13A is a flow chart illustrating an example method 1300 for assembling a connector and attaching the connector to a photonic integrated circuit of a silicon photonic assembly. At operation 1310, a fiber array unit is assembled. The fiber array unit may comprise one or more grooves, and the grooves may be V-grooves in some embodiments. In some embodiments, operation 1310 may be executed by performing the method 1310A of FIG. 13B.

At operation 1320, a fiber array unit (FAU) micro lens array (MLA) is attached to the fiber array unit directly or indirectly. In some embodiments, the fiber array unit micro lens array may be attached indirectly by attaching the fiber array unit micro lens array to an intermediate connector, and the intermediate connector may be attached directly or indirectly to the fiber array unit. In some embodiments, operation 1320 may be executed by performing the method 1320A of FIG. 13C. At operation 1330, a photonic integrated circuit micro lens array is attached directly or indirectly to the receptacle. In some embodiments, operation 1330 may be executed by performing the method 1330A of FIG. 13D. At operation 1340, the receptacle is attached to the photonic integrated circuit. In some embodiments, operation 1340 may be executed by performing the method 1340A of FIG. 13E or by performing the method 1340B of FIG. 13F.

FIG. 13B illustrates an example method 1310A for assembling a fiber array unit. In some embodiments, the method 1310A may be performed in place of operation 1310 in the method 1300A of FIG. 13A. At operation 1312, a fiber array unit is prepared. In some embodiments, this preparation may entail simply obtaining a fiber array unit. However, in other embodiments, this preparation may entail the manufacture of the fiber array unit. The fiber array unit may be manufactured by obtaining base material of the appropriate size. This base material may be processed to form one or more grooves. One or more pin grooves may be manufactured to at least partially receive pins to assist in maintaining alignment, and one or more fiber grooves may be manufactured to at least partially receive fibers therein. Each of these grooves may be V-grooves in some embodiments, but grooves may also possess other shapes.

At operation 1314, fibers are attached to the fiber array unit. The fibers may be positioned in the grooves of the fiber array unit. In some embodiments, the fibers may be polarization maintaining fibers or other fibers where the angular orientation of the fibers must be maintained. Where this is the case, care may be taken during assembly to ensure that fibers are positioned at the correct angular orientation. Fibers may be positioned in each of the grooves of the fiber array unit. However, in some embodiments, one or more of the grooves may not be filled with fibers or one or more of the grooves may be filled with dummy fibers or objects other than fibers.

At operation 1316, a lid may be assembled to the fiber array unit. In some embodiments, the lid may assembled so that the lid is in contact with some or all of the fibers introduced at operation 1314. The lid may assist in maintaining the position of the fibers within the fiber array unit, and, in some embodiments, the lid may assist in maintaining the angular orientation of the fibers. This may be particularly beneficial where polarization maintaining fibers are used. The lid may be assembled and attached in a variety of ways. For example, the lid may be attached using adhesive, mechanical fasteners, or other attachment devices. In some embodiments, the lid may completely cover fibers positioned in grooves on the fiber array unit. However, in other embodiments, the lid may only partially cover the fibers positioned in grooves on the fiber array unit, or a lid may not cover the fibers at all (e.g., the lid may be omitted). At operation 1318, one or more surfaces of the fiber array unit may be polished, and this may ensure the appropriate alignment of the fiber array unit and the FAU micro lens array. The front surface of the fiber array unit may be polished and/or refined at operation 1318, but other surfaces of the fiber array unit may also be polished or refined in other ways.

FIG. 13C illustrates an example method 1320A for attaching a fiber micro lens array to a fiber array unit. In some embodiments, the method 1320A may be performed in place of operation 1320 in the method 1300A of FIG. 13A. At operation 1322, fiber positions in the fiber array unit are determined. At operation 1324, lens positions in the FAU micro lens array are determined. In some embodiments, the determination of lens positions and fiber positions may be performed through visual recognition alone. However, these determinations may also be performed through the use of one or more tools or through the use of other computing devices and/or sensors to ensure precise and accurate determinations for the positions. At operation 1326, appropriate positioning of the FAU micro lens array relative to the fiber array unit is determined. This may be determined based on the fiber positions determined in operation 1322 and based on the lens positions determined in operation 1324. At operation 1328, the FAU micro lens array is positioned relative to the fiber array unit based on the determination at operation 1326. In some embodiments, the FAU micro lens array may be attached directly to the fiber array unit, but the FAU micro lens array may be attached indirectly to the fiber array unit (e.g., by attaching FAU micro lens array directly to a receptacle and by attaching the receptacle directly to the micro lens array).

FIG. 13D illustrates an example method 1330A for attaching a photonic integrated circuit micro lens array. In some embodiments, the method 1330A may be performed in place of operation 1330 in the method 1300A of FIG. 13A. At operation 1332, a golden sample fiber array unit is positioned and/or attached to another component to hold the golden sample fiber array unit in place. This attachment may be a direct or indirect attachment. This golden sample fiber array unit may be a product that completely aligns with the required product quality standards and that falls within each of the required tolerances. This golden sample fiber array unit may already have fibers positioned therein, and a lid may optionally be included in the golden sample fiber array unit. At operation 1333, light is injected into one or more of the fibers of the golden sample fiber array unit. Where light is injected into only some of the fibers, light will preferably be injected into fibers at the ends of a fiber array as these fibers tend to suffer from the greatest coupling losses where angular alignment is incorrect. At operation 1334, a mirror may be positioned in the beam of light. This mirror may be positioned at the location where photonic integrated circuit waveguides would be located. At operation 1335, the mirror may be adjusted so that the beam of light is reflected back into the fibers. The mirror may be adjusted so that the amount of light that is reflected back into the fibers is maximized, with this amount of light being measured by a splitter. At operation 1336, the photonic integrated circuit micro lens array is positioned in the beam of light so that the reflected signal is maximized. This amount of light may be measured by a splitter. The photonic integrated circuit micro lens array may be attached to one or more components at the position identified in operation 1336 in some embodiments so that the photonic integrated circuit micro lens array remains fixed at that location. For example, the photonic integrated circuit micro lens array may be attached to a receptacle or to another component. The method 1330A of FIG. 13D may assist in angularly aligning the photonic integrated circuit micro lens array relative to the connector micro lens array.

FIG. 13E illustrates an example method 1340A for attaching a receptacle to a photonic integrated circuit. In some embodiments, the method 1340A may be performed in place of operation 1340 in the method 1300A of FIG. 13A. At operation 1342A, a golden sample fiber array unit is attached to the receptacle. This golden sample fiber array unit may be a product that completely aligns with the required product quality standards and that falls within each of the required tolerances. This golden sample fiber array unit may already have fibers positioned therein, and a lid may optionally be included in the golden sample fiber array unit. At operation 1344A, light is injected into one or more of the fibers of the golden sample fiber array unit. Where light is injected into only some of the fibers, light will preferably be injected into fibers at the ends of a fiber array as these fibers tend to suffer from the greatest coupling losses where angular alignment is incorrect. At operation 1346A, the receptacle is positioned in the beam of light so that the signal is maximized in the waveguides, and the receptacle may eventually be fixed in this position.

FIG. 13F illustrates an alternative method 1340B for attaching a receptacle to a photonic integrated circuit. In some embodiments, the method 1340B may be performed in place of operation 1340 in the method 1300A of FIG. 13A. At operation 1342B, the receptacle may be attached to an intermediate alignment structure. For example, the intermediate alignment structure may be a lid of a fiber array unit. However, in some embodiments, operation 1342B may be omitted. Attachment may be accomplished through the use of adhesive, fasteners, or other attachment mechanisms. At operation 1344B, a golden sample fiber array unit is attached to the receptacle. This golden sample fiber array unit may already have fibers positioned therein, and a lid may optionally be included in the golden sample fiber array unit. At operation 1346B, light is injected into one or more of the fibers of the golden sample fiber array unit. At operation 1348B, the receptacle and the intermediate alignment structure are positioned relative to the beam of light so that the signal is maximized in the waveguides, and the receptacle may eventually be fixed in this position by attachment to other components.

Methods illustrated in the flow charts of FIGS. 13A-13F are merely exemplary, and it should be understood that the methods may be modified in various ways. For example, the operations may be performed in different orders than the orders presented in FIGS. 13A-13F. Some of the operations may also be performed simultaneously in some embodiments. Additionally, the methods may be combined in some embodiments. For example, the methods presented in FIGS. 13B-13E may be combined in some embodiments, or the methods presented in FIGS. 13B-13D and 13F may be combined in some embodiments. Additional operations may be added in some embodiments, and certain operations may be omitted.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. An assembly for expanded beam coupling a fiber array unit (FAU) to a photonic integrated circuit (PIC), the assembly comprising:
the photonic integrated circuit (PIC);
a PIC micro lens array attached to the photonic integrated circuit;
the fiber array unit (FAU), the FAU comprising one or more grooves, each of the one or more grooves being configured to receive a fiber therein;
an FAU micro lens array attached to the FAU, the FAU micro lens array being offset from the PIC micro lens array by a first distance; and
at least one alignment feature configured to control an angular alignment of the PIC micro lens array relative to the FAU micro lens array,
wherein the PIC micro lens array and the FAU micro lens array have a gap, an angular offset, and a lateral offset between the PIC micro lens array and the FAU micro lens array.

2. The assembly of claim 1, wherein the assembly is configured so that an optical beam emitted between the PIC micro lens array and the FAU micro lens array has a diameter at the PIC micro lens array that is approximately the same as a diameter at the FAU micro lens array.

3. The assembly of claim 1, further comprising a pin, the pin configured to align the FAU relative to the PIC.

4. The assembly of claim 3, wherein the FAU defines an FAU pin groove configured to receive a first portion of the pin therein.

5. The assembly of claim 4, wherein the at least one alignment feature includes a receptacle defining a receptacle pin groove configured to receive a second portion of the pin therein.

6. The assembly of claim 5, wherein receipt of the pin within the FAU pin groove and the receptacle pin groove aligns the FAU relative to the receptacle.

7. The assembly of claim 5, wherein the PIC micro lens array and the FAU micro lens array are positioned proximate to the receptacle.

8. The assembly of claim 5, further comprising:
a plate comprising a first surface and a second surface opposite the first surface; and a housing configured to maintain positioning of the FAU relative to the receptacle, the housing comprising a plurality of retention walls including a first retention wall and a second retention wall offset from the first retention wall by an offset distance, the plurality of retention walls defining an interior volume within the housing, comprising a plurality of retention walls including a first retention wall and a second retention wall offset from the first retention wall by an offset distance, the plurality of retention walls defining an interior volume within the housing,
wherein the at least one alignment feature includes the housing,
wherein the housing is configured to receive at least a portion of the plate, the receptacle, and the FAU in the interior volume of the housing,
wherein the first surface of the plate is positioned in contact with the first retention wall of the housing,
wherein the receptacle is positioned in contact with the second surface of the plate, and
wherein the second retention wall is positioned in contact with the FAU to maintain a position of the FAU relative to the plate and the receptacle.

9. The assembly of claim 8, wherein the plurality of retention walls includes a third retention wall, wherein the first retention wall and the third retention wall extend in different planes, and wherein the first retention wall and the third retention wall each contact at least one of the plate, the receptacle, or the FAU to assist in controlling alignment.

10. The assembly of claim 1, the PIC micro lens array is directly attached to the PIC.

11. The assembly of claim 1, wherein the FAU micro lens array is directly attached to the FAU.

12. The assembly of claim 1, wherein each of the one or more grooves are V-grooves.

13. The assembly of claim 8, further comprising:
a second housing and a third housing;
a second fiber array unit and a third fiber array unit; and
wherein the second housing is configured to maintain positioning of the second fiber array unit, the third housing is configured to maintain positioning of the third fiber array unit, and the second housing is offset along a first direction relative to the housing and the third housing.

14. A connector for connection to a photonic integrated circuit (PIC) by expanded beam coupling, the connector comprising:
a fiber array unit (FAU), the FAU comprising one or more grooves, each of the one or more grooves being configured to receive a fiber therein;
an FAU micro lens array attached to the FAU; and
at least one alignment feature configured to control an angular alignment of the FAU micro lens array relative to a PIC micro lens array,
wherein the FAU micro lens array is configured to be offset from the PIC micro lens array of the PIC by a first distance,
the at least one alignment feature being configured to assist in controlling an angular alignment of the being configured to receive a fiber therein;
an FAU micro lens array attached to the FAU; and
at least one alignment feature configured to control an angular alignment of the FAU micro lens array relative to a PIC micro lens array,
wherein the FAU micro lens array is configured to be offset from the PIC micro lens array of the Pic by a first distance,
the at least one alignment feature being configured to assist in controlling an angular alignment of the
FAU micro-lens array relative to the PIC micro lens array, and
wherein the FAU micro lens array and the PIC micro lens array have a gap, an angular offset, and a lateral offset between the FAU micro lens array and the PIC micro lens array.

15. The connector of claim 14, further comprising:
a plate comprising a first surface and a second surface opposite the first surface; and a housing configured to maintain positioning of the FAU relative to a receptacle, the housing comprising a plurality of retention walls including a first retention wall and a second retention wall offset from the first retention wall by an offset distance, the plurality of retention walls defining an interior volume within the housing,
wherein the at least one alignment feature includes the housing,
wherein the housing is configured to receive at least a portion of the plate, the receptacle, and the fiber array unit in the interior volume of the housing,
wherein the first surface of the plate is positioned in contact with the first retention wall of the housing,
wherein the receptacle is positioned in contact with the second surface of the plate, and
wherein the second retention wall is positioned in contact with the FAU to maintain a position of the FAU relative to the plate and the receptacle.

16. The connector of claim 15, wherein the plurality of retention walls includes a third retention wall, wherein the third retention wall extends in a different plane relative to the first retention wall, and wherein the first retention wall and the third retention wall each contact at least one of the plate, the receptacle, or the FAU to assist in controlling alignment.

17. The connector of claim 14, wherein the connector is configured so that an optical beam emitted between the PIC micro lens array and the FAU micro lens array has a diameter at the PIC micro lens array that is approximately the same as a diameter at the FAU micro lens array.

18. A method for manufacturing an expanded beam coupling assembly, the method comprising:
providing a fiber array unit (FAU) comprising a plurality of grooves;
positioning a plurality of fibers within the FAU, with each fiber of the plurality of fibers being positioned at least partially within a respective groove of the plurality of grooves;
positioning the FAU relative to a receptacle;
positioning an FAU micro lens array on the receptacle relative to the FAU;
positioning a photonic integrated circuit (PIC) micro lens array on the receptacle so that the PIC micro lens array is offset from the FAU micro lens array by a first distance;
positioning a PIC relative to the receptacle so that the PIC is positioned proximate to the PIC micro. lens array; and
positioning at least one alignment feature to control an angular alignment of the FAU micro lens array relative to the PIC micro lens array,
wherein the FAU micro lens array and the PIC micro lens array have a gap, an angular offset, and a lateral offset between the FAU micro lens array and the PIC micro lens array.

19. The method of claim 18, wherein the positioning of the FAU micro lens array on the receptacle relative to the FAU is accomplished by attaching the FAU micro lens array to the fiber array unit.

20. The method of claim 18, wherein the FAU micro lens array is positioned so that an optical beam emitted between the PIC micro lens array and the FAU micro lens array has a diameter at the PIC micro lens array that is approximately the same as a diameter at the FAU micro lens array.
